(19) United States
(12) Patent Application Publication
(10) Pub. No.: US 2021/0350038 A1
(43) Pub. Date: Nov. 11, 2021

(54) Systems and Methods for Rapidly Developing Annotated Computer Models of Structures

(71) Applicant: Insurance Services Office, Inc., Jersey City, NJ (US)

(72) Inventors: Jacob Jenson, Cedar Hills, UT (US); Corey David Reed, Cedar Hills, UT (US); Brandon O'Very, Saratoga Springs, UT (US); Ron Richardson, South Jordan, UT (US); Benjamin Jankowski, Lehi, UT (US)

(73) Assignee: Insurance Services Office, Inc., Jersey City, NJ (US)

(21) Appl. No.: 17/329,098

(22) Filed: May 24, 2021

Related U.S. Application Data
(63) Continuation-in-part of application No. 17/122,080, filed on Dec. 15, 2020.
Application No. 17/122,080 is a continuation-in-part of application No. 16/189,512, filed on Nov. 13, 2018.
(60) Provisional application No. 62/585,078, filed on Nov. 13, 2017.

(51) Int. Cl. G06F 30/12; G06F 30/13; G06F 3/0484; G06F 16/332

(52) U.S. Cl. CPC G06F 30/12; G06F 16/3329; G06F 3/0484; G06F 30/13

(57) ABSTRACT

Systems and methods for rapidly developing annotated computer models of structures and properties is provided. The system generates three-dimensional (3D) models of structures and property using a wide variety of digital imagery, and/or can process existing 3D models created by other systems. The system processes the 3D models to automatically identify candidate objects within the 3D models that may be suitable for annotation, such as roof faces, chimneys, windows, gutters, etc., using computer vision techniques to automatically identify such objects. Once the candidate objects have been identified, the system automatically generates user interface screens which gather relevant information related to the candidate objects, so as to rapidly obtain, associate, and store annotation information related to the candidate objects. When all relevant annotation information has been gathered and associated with model objects, the system can create a list of materials that can be used for future purposes, such as repair and/or reconstruction of real-world structures and property. The system also allows for modeling of water damage of a structure, as well as generating lists of tasks for mitigating the water damage and associated costs.

### CROSS-REFERENCE TO RELATED APPLICATIONS

This application is a continuation-in-part of U.S. patent application Ser. No. 17/122,080 filed on Dec. 15, 2020, which is a continuation-in-part of U.S. patent application Ser. No. 16/189,512 filed Nov. 13, 2018, each of which claims the benefit of U.S. Provisional Patent Application No. 62/585,078, filed on Nov. 13, 2017, the entire disclosures of which are both expressly incorporated herein by reference.

### BACKGROUND

### Field of the Disclosure

The present disclosure relates to computer modeling of structures and property. More specifically, the present disclosure relates to systems and methods for rapidly developing annotated computer models of structures.

### Related Art

It is well-known in the field of computer-aided design (CAD) to utilize software products to create computer models of structures. Indeed, for many years, computers have been used to develop models of structures and property for various purposes. For example, various, customized software packages have been developed for many years which allow insurance companies, contractors, and other entities, to create models of structures and properties. One such example is the XACTIMATE software package, which is widely used in the insurance claims processing industry to create computerize models of buildings and materials for purposes of repairing and replacing structures due to property damage and other causes.

In addition to the above, there have been rapid advances in the fields of computer-generated models of structures and property by applying computer vision techniques to digital imagery (e.g., aerial imagery, satellite imagery, etc.) to create three-dimensional (3D) models of such structures. Examples of widely-used software packages which generate such models from aerial imagery include the GEOMNI ROOF and GEOMNI PROPERTY software packages.

These systems create complex, three-dimensional models of structures by processing features in aerial images.

While the advent of computer vision techniques have made the process of creating models of structures (and property) easier to accomplish than was previously possible, there is still a need to rapidly create annotated computer models of structures, e.g., models of buildings, property, and other structures which not only accurately model the real-world structures that they represent, but also are annotated with rich information delineating real-world attributes relating to such structure. Accordingly, the systems and methods of the present disclosure address these shortcomings of existing technologies.

### SUMMARY

The present disclosure relates to systems and methods for rapidly developing annotated computer models of structures and property. The system can generate three-dimensional (3D) models of structures and property using a wide variety of digital imagery, and/or can process existing 3D models created by other systems. The system processes the 3D models to automatically identify candidate objects within the 3D models that may be suitable for annotation, such as roof faces, chimneys, windows, gutters, etc., using computer vision techniques to automatically identify such objects. Additionally, for each identified object, the system also automatically searches for and identifies additional related objects that may be suitable candidates for annotation. Once the candidate objects have been identified, the system automatically generates user interface screens which gather relevant information related to the candidate objects, so as to rapidly obtain, associate, and store annotation information related to the candidate objects. Additionally, the system dynamically adjusts questions presented to users in the user interface screens so as to increase the speed with which relevant information is obtained from users and associated with the objects of the model. When all relevant annotation information has been gathered and associated with model objects, the system can create a list of materials that can be used for future purposes, such as repair and/or reconstruction of real-world structures and property. The system additionally allows for rapid development of annotated models relating to water damage and/or mitigation of a structure.

### BRIEF DESCRIPTION OF THE DRAWINGS

The foregoing features of the disclosure will be apparent from the following Detailed Description, taken in connection with the accompanying drawings, in which:

FIG. 1 is a flowchart illustrating high-level processing steps carried out by the system of the present disclosure;

FIG. 2 is a diagram illustrating processing step 18 of FIG. 1 in greater detail;

FIGS. 3-4 are diagrams illustrating visualizations of the computer models generated by the system of the present disclosure, including candidate objects automatically identified by the system for annotation;

FIGS. 5-6 are screenshots illustrating sample user interface screens generated by the system for allowing annotation of selected objects of the model;

FIG. 7 is a screenshot illustrating a unified user interface generated by the system of the present disclosure, wherein the user can select candidate objects of the model and create associated annotations in a single user interface;

FIG. 8 is a screenshot illustrating a materials and price list automatically generated by the system based on the annotated model generated by the system;

FIG. 9 is a diagram illustrating sample hardware components on which the system of the present disclosure could be implemented;

FIG. 10 is a diagram of another embodiment of the system of the present disclosure, wherein an annotated computer model of water damage and/or mitigation relating to a structure can be generated;

FIG. 11 is a diagram illustrating a water damage and/or mitigation model capable of being generated by the system of the present disclosure;

FIG. 12 is a diagram illustrating the user interface of the system of present disclosure, wherein water damage and/or mitigation zones are defined;

FIG. 13 is diagram illustrating a user interface tool for defining barriers between water damage and/or mitigation zones of the model;

FIG. 14 is diagram illustrating a user interface tool for selecting one or more water damage and/or mitigation zones of the model;

FIG. 15 is diagram illustrating a user interface tool for guided capturing of information relevant to modeling of water damage and/or mitigation of a structure;

FIGS. 16-17 are diagrams illustrating user interface tools for performing calculations for equipment relating to water damage and/or mitigation of a structure;

FIG. 18 is a diagram illustrating a report generated by the system listing tasks and associated costs for mitigating water damage of a structure as modeled by the system;

FIG. 19 is a screenshot of another embodiment of the system of the present disclosure illustrating a unified user interface generated by the system of the present disclosure, wherein an annotated computer model of a structure can be generated;

FIG. 20 is a diagram illustrating a toolbar of the unified user interface of FIG. 19;

FIG. 21 is another screenshot illustrating the unified user interface generated by the system of the present disclosure, wherein an annotated computer model of a structure can be generated;

FIG. 22 is a diagram of another embodiment of the system of the present disclosure illustrating a mitigation barrier generated by the system of the present disclosure;

FIG. 23 is diagram illustrating a toolbar for generating a floorplan of a model and selecting and positioning one or more objects in the floorplan of the model;

FIG. 24 is a diagram illustrating a floorplan of the model of FIG. 22 capable of being generated by the system of the present disclosure;

FIG. 25 is another screenshot illustrating the unified user interface generated by the system of the present disclosure, wherein information relevant to water damage and/or mitigation can be captured;

FIG. 26 is another screenshot illustrating the unified user interface generated by the system of present disclosure, wherein water damage and/or mitigation zones can be defined;

FIG. 27 is another screenshot illustrating the unified user interface generated by the system of the present disclosure, wherein information relevant to water damage and/or mitigation can be captured;

FIGS. 28-31 are diagrams illustrating additional user interface screen generated by the system of the present disclosure, wherein information relating to placement and operational status of various water mitigation equipment can be graphically accessed and managed;

FIGS. 32-34 are diagrams illustrating additional user interface screens generated by the system of the present disclosure, wherein moisture information can be easily logged, accessed, and managed.

### DETAILED DESCRIPTION

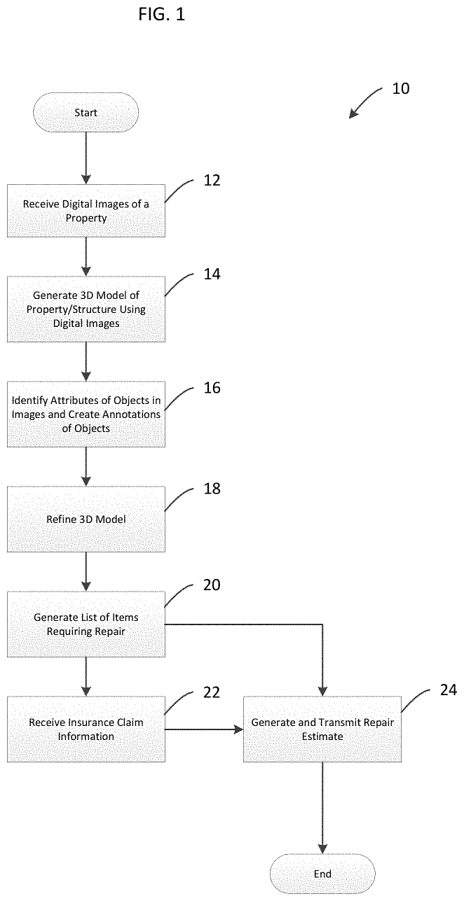

The present disclosure relates to systems and methods for rapid development of annotated computer models of structures and property, as described in detail below in connection with FIGS. 1-34.

FIG. 1 is a diagram illustrating overall process steps carried out by the system, indicated generally at 10. As noted above, the system of the present disclosure provides a single, unified, computer-based tool and associated user interface which allows a user to rapidly and accurately generate detailed, annotated, object-based models of properties and structures. Beginning in step 12, the system could receive one or more digital images of a property. Such images could be stored locally, retrieved from a database (local or remote), and/or retrieved from a third-party digital imagery provider's computer system(s). Images of a property could be gathered from many possible sources including, but not limited to, satellites, aircraft, drones, and from ground-based cameras. As each image is captured, a set of metadata could be generated by the system, which describes the image. The metadata can include, but is not limited to: GPS coordinates, altitude, direction of the camera, angle of the camera, camera intrinsic parameters, date and time of capture, etc. The actual image and the metadata for that image are stored together by the system as an image “set.” A group of image sets could then be combined into a package associated with a particular location. Such a package can be stored (e.g., on a server) and retrieved on demand. While the system of the present disclosure is not limited by any particular techniques for acquiring digital images and associated metadata (and, indeed, the system could utilize images that have already been acquired and processed to include metadata, e.g., from a third party imagery provider), one example of a technique for acquiring images of structures and properties is disclosed in co-pending U.S. Provisional Application Ser. No. 62/512,989, the entire disclosure of which is expressly incorporated by reference herein in its entirety.

In step 14, the images and metadata (package) can be processed by the system using one or more computer vision algorithms to create a three-dimensional (3D) model of the property/structure, as well as damage to such property/structure. It is noted that the system need not create a 3D model from aerial images, and indeed, the system could receive and process a previously-created 3D model that is transmitted to the system from another computer, if desired. If it is desired to create a 3D model from multiple images of the same property, there are numerous ways that such a 3D model can be generated. Known software tools can be used which perform sophisticated image processing algorithms to automatically extract the information from the images and generate the model. Other software tools allow operators to manually generate the models with some computer assistance. Still other tools use a combination of automatically generated and manually generated models. In any case, the result is a raw geometric model consisting of polygons, line segments and points. If the system is utilized to generate a 3D model from the aerial imagery, various techniques could be used by the system to carry out such modeling, including but not limited to, one or more of the techniques disclosed in issued U.S. Pat. Nos. 9,679,227 and 9,501,700; published PCT Application No. PCT/US2016/065947; and U.S. patent application Ser. No. 15/277,359, the entire disclosures of which are expressly incorporated herein by reference, or any other suitable techniques.

In step 16, the system identifies attributes of objects in the property, and annotates the 3D model of the property/structure. In particular, in this step, the system automatically identifies components of the 3D model, such as points, lines, panels, geometric shapes, and free shapes, as candidates for annotation. For example, the system could automatically include points of the model as candidate structures for annotation as roof vents, lines of the model as candidate structures for annotation as gutters, panels (planar sections) of the model as candidate structures for annotation as skylights or windows, and various geometric shapes as candidates for annotation as other structures such as trees, vegetation, etc. Such automatic selection of objects of the 3D model as candidates for annotation could be accomplished using known computer vision techniques such as edge detection and classification techniques, region growing techniques, machine learning, etc. Such attributes and associated annotation(s) can include, but are not limited to:
Point elements for annotation: roof vents, finials, HVAC, bin containers, etc.
Line elements to annotate: rain gutters, cornices, ridge vents, railings, etc.
Panel elements to annotate: solar skylights, panels, entrances, garage doors, windows, etc.
Geometric shapes to annotate: roads, pools, sport courts, trampolines, etc.
Free shapes to annotate: trees, vegetation, etc.

Any elements can have specific features associated therewith. For example, exterior walls could be made from brick, stone, stucco, metal or some other material. Roofs could be made from asphalt shingles, ceramic tile, shake, metal, etc. Roof vents could be turbine, turtle or some other type of vent. When the features are associated with a candidate object for annotation, they are stored as part of the annotation. The annotation information can be generated manually, through an automated process, or through some combination of the two. The automated process utilizes computer vision and machine learning techniques. The automated annotations can be broken into two types: structural and non-structural annotations. Structural annotations are elements that are attached to the 3D model of a structure. Examples of structural annotations are: roof vents, skylights, solar panels and roof materials. Non-structural annotations are those not related to any 3D model. Examples of non-structural annotations are: pools, trees, trampolines, and concrete flatwork.

When annotations are entered manually, the system assists the operator in identifying, locating and entering elements associated with real-world items into the model. The system projects properly-oriented models onto different images of the property from different sources and orientations, to assist the user with annotation. The operator can then interact with the tool by adding a new property feature to the model, removing an existing property feature, or adding additional information about an existing property feature. These manual annotations can be entered at the time of the model creation or anytime afterward.

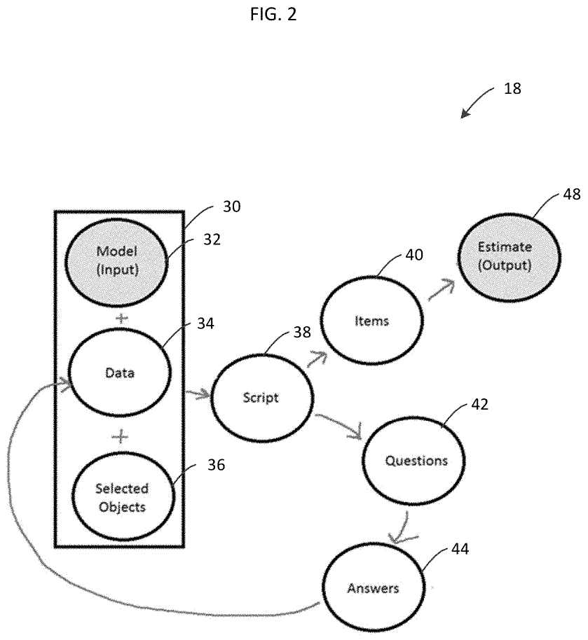

In step 18, the system refines the 3D model after attributes of objects in the model have been identified an annotated, as noted above. An interactive process is implemented in step 18, and is illustrated in greater detail in connection with FIG. 2. In step 30, the model 32, associated model data 34, and selected objects 36 are processed by a script 38 which automatically generates a list of items 40 and questions 42 to be answered by the user of the system. The model 32 is the 3D representation of a property and the real world objects associated with it as described previously. The data 34 represents the “pre-filled” annotation information supplied through an automated process, manually by an operator and/or the information gleaned from the answers to the questions for each of the property objects. The selected objects 36 provide the operator with the ability to select one or more property objects. This allows the operator to focus his attention on one thing or aspect of the property at a time. The script 38 directs the information coming from the combination of the model, the data and the selected objects to form a set of questions which is presented to the operator. The questions 42 prompt the operator for input details related to the selected objects. Only questions relevant to the selected objects and to previously answered questions are shown to the operator, in response to which the operator provides answers 44. The answers 44 are then saved with the model 30. Changes in data 34 may cause the script to perform a different set of steps, therefore at each question change, the process is cycled and a potentially new set of questions is generated. The items 40 represent a listing of the real world purchasable items and quantities for all property objects. This list is then passed to the estimate 48 as the final output for this given process. External to the process, the list of generated items is then associated with a price for the area where the property exists. Given the item prices, the quantity, the taxes, and other information relevant to the claim (such as deductible), an estimate of the cost to replace and the indemnity to the policy holder can be created.

Turning back to FIG. 1, once the model has been refined in step 18, in step 20 the system generates the list of items 40 as noted above. Then, in step 22, the system could optionally process insurance claim information, if desired. Finally, in step 24, the system processes both the list of items requiring repair and any insurance claim information to generate and transmit a repair estimate.

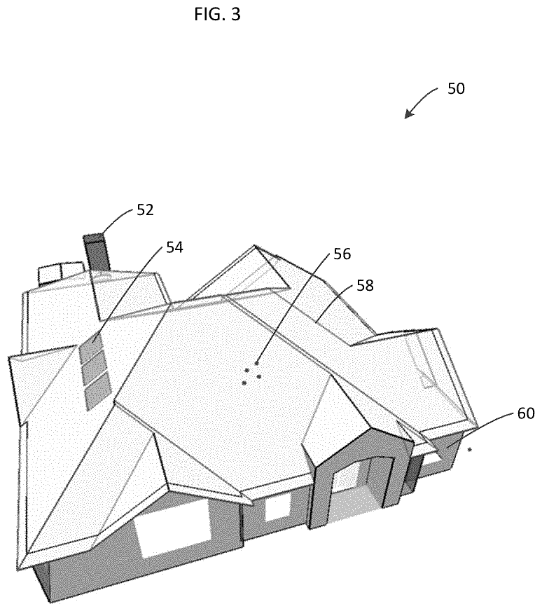

FIG. 3 is a diagram showing a visualization of the model, indicated generally at 50. Various colors could be included in the model to represent the types of property objects. Red lines, for example, could represent roof valleys, blue lines (58) could represent roof ridges, green lines could represent eaves and rakes, etc. Any desired type of indicia could be used to indicate different roof elements. The rectangles 54 of the model represent skylights. The rectangle 52 could represent a chimney top, and the green dots 56 could represent roof vents. Walls 60 could also be represented in the model 50. Connected together, the operator can match the real world objects with the model as it is stored internally in memory in a computer system.

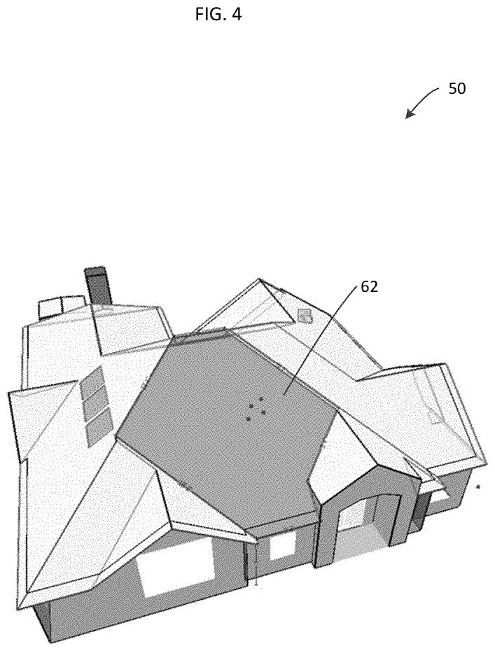

As shown in FIG. 4, the user interface of the system provides the user with the ability to select an object of the model by clicking on it, and to define attributes of that object and to annotate the object. As shown, the user can select a roof face 62 of the model 50 by clicking on the face 62. The face 62 is highlighted to provide feedback to differentiate the selected object. To assist the operator, all touching lines and enclosed single roof objects (in this case vents) can automatically be included by the system, and automatically identified as objects that are candidates for annotation as described below. Indeed, for example, when the user clicks on the roof face 62, the system searches for all objects in the model, such as ridge vents, gutters, underlayments, etc., that contact or form part of the roof face 62, and automatically labels those objects as candidates for further annotation. Thus, since the system automatically (through computer vision techniques) delineates candidate objects in the model for annotation, the system rapidly increases the efficiency and speed with which annotated computer models of structures are developed.

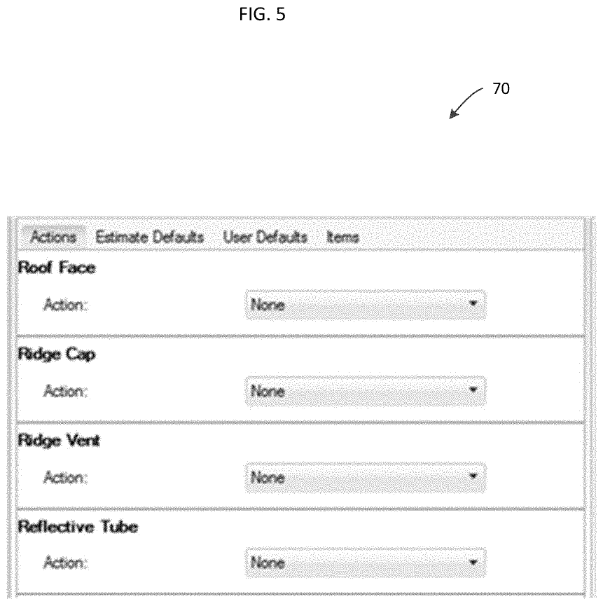

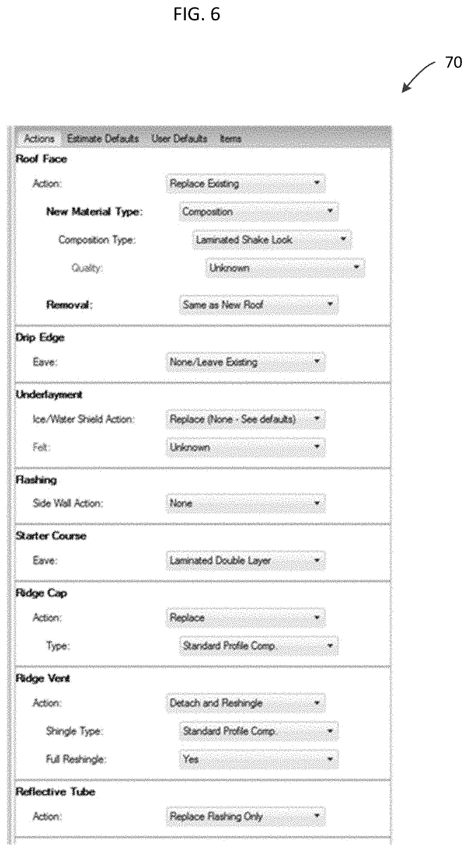

The annotation process enabled by the system of the present disclosure will now be described in greater detail. When the user clicks on the object (roof face) 62, the user interface of the system automatically generates a user interface screen 70 as shown in FIG. 5. Given the model, the data, and the selected information, a software script of the system can automatically generate a set of appropriate questions as shown in the screen 70 of FIG. 5. The user must first determine what repairs need to be done with the roof face 62. If no information has been “pre-filled” in this regard, the script presumes that nothing will be done unless the operator specifically selects an action. However, as shown in the user interface screen 70 of FIG. 6, if the user desires to take an action, the user can do so using the various drop-down boxes which are automatically generated by the system. For this example, the operator can pick the drop down action of “Replace Existing” as shown in FIG. 6. This causes the screen 70 to automatically generate further questions to be answered by the user using drop-down boxes, such as specifying the new type of roof material to be used, composition type of the roof material, quality of the roof material, information relating to removal of the material, etc. By processing the user's answer to generate further questions, the system recycles the process and causes the automatic regeneration of a set of questions as illustrated in FIG. 6. Having determined that the roof is going to be replaced, the user interface 70 automatically generates questions which show the user that it is also possible to replace the drip edge, the flashing, the starter course and other material associated with replacing the face, as prompted by the additional questions and drop-down boxes shown in FIG. 6.

Note that the “New Material Type” question shown in the user interface 70 in FIG. 6 contains the value of “Composition” and the “Composition Type” question contains the value of “Laminated Shake Look”. This is part of the “pre-filled” data that was obtained at the time the property model was created. The operator does not need to pick an answer to these questions unless the “pre-fill” data were incorrectly determined. The quality question under the “Composition Type” has a current answer of “Unknown” for purposes of illustration only. That piece of information could be supplied by the operator by inspecting the property in person, looking at receipts, or by other means, if desired.

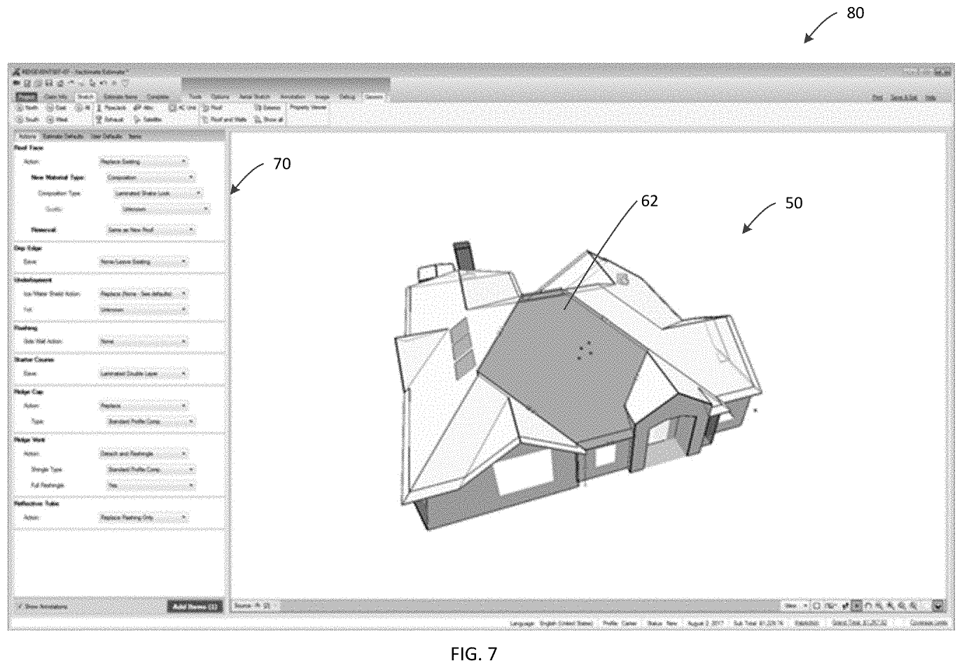

FIG. 7 illustrates a unified user interface 80 generated by the system, which allows the user to interact in a single user interface with the 3D model 50 of the structure as well as the user interface screen 70 for annotating the model and specifying information about objects of the model, as discussed above, using targeted responses to questions automatically generated by the system. Each answer to a question provided by the user (e.g., by changing selections of the pull-down prompts in response to associated questions) cycles the process back to regenerating the questions dynamically, thus providing a rich user interface which elicits the most relevant information from the user related to objects in the model. The process continues iteratively until the operator has picked an answer for each question for each object (such that multiple objects can be selected at once). In so doing, the system allows for the rapid generation of annotated computer models of structures and property.

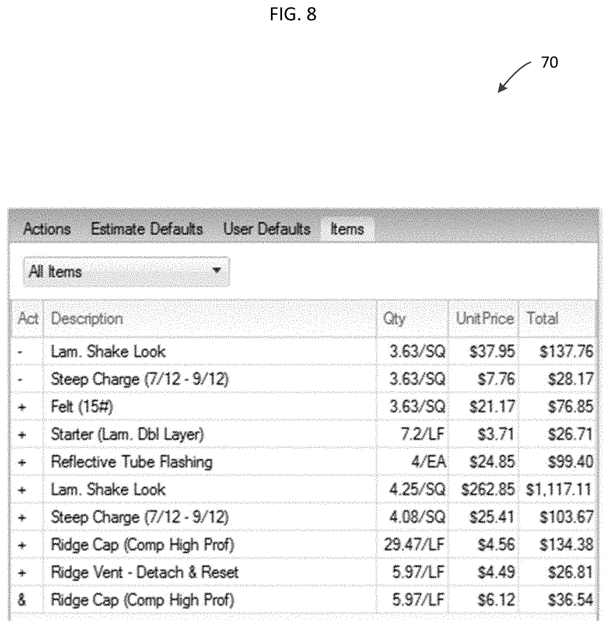

As part of the iterative process, a set of real-world items is generated each time an answer to a question is changed. This is illustrated in the version of the user interface 70 shown in FIG. 8. As can be seen, the user interface 70 displays items that can be purchased for the purpose of repairing the property. The unit pricing could be provided by an estimation software package. Furthermore, the resultant items list can be linked to an insurance claims software and an estimation software package to generate the insurance estimate.

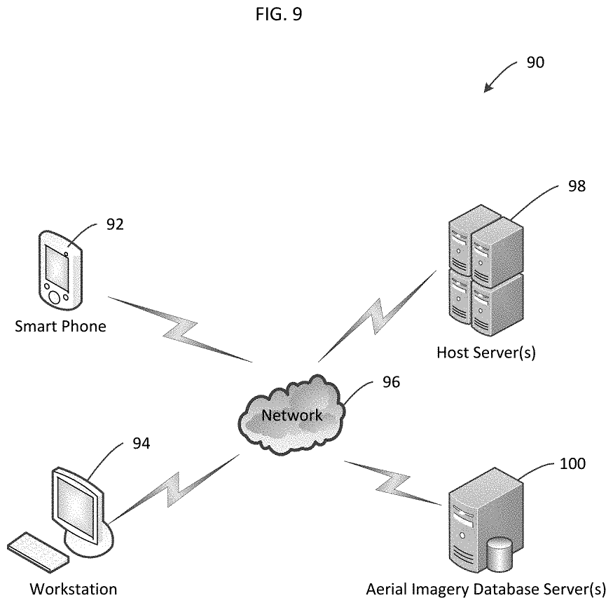

FIG. 9 is a diagram illustrating sample hardware components 90 on which the present invention could be implemented. The system could be implemented on a computer system using any suitable programming language such as C, C++, C#, Java, Python, or other suitable programming language, and could be embodied as computer-readable and executable code executed by a suitable computer system, such as one or more host servers 98. Such servers could be cloud-based servers that are accessible from one or more user devices such as smart phones 92 or workstations 94 which are in communication with the servers 98 via a network 96 (e.g., over the Internet). The servers 98 could also communicate with one or more aerial imagery database servers 100 in order to obtain and process aerial imagery to generate 3D models of structures and property depicted in such imagery, as disclosed herein. Still further, the system of the present disclosure could be implemented entirely on an end-user device if desired, in the form of a program installed on and executed by the phone 92 and/or workstation 94.

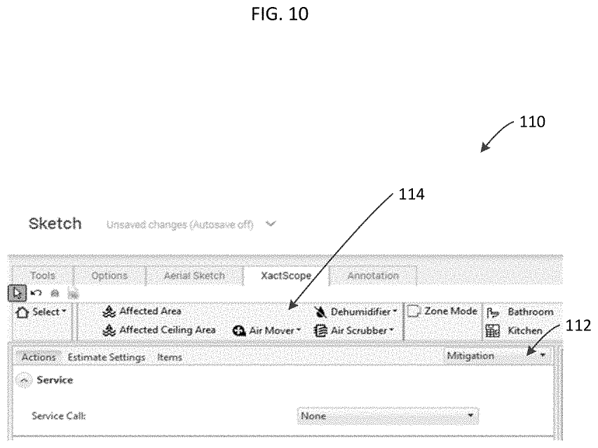

The systems and methods disclosed herein could be extended to allow users to rapidly develop annotated computer models of water damage relating to a structure, as well as tasks and costs associated with mitigating such damage. Such embodiments of the system will now be disclosed in connection with FIGS. 10-18.

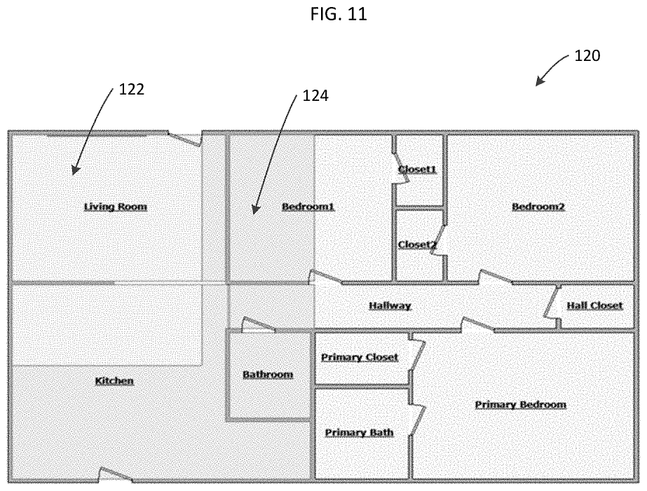

FIG. 10 is a diagram of another embodiment of the system of the present disclosure, wherein an annotated computer model of water damage and/or mitigation relating to a structure can be generated. The system generates a user interface 110 and associated tools that assist a user in accurately scoping the cost of work needed to mitigate water damage to a property. This includes the various materials, labor, and calculations for equipment such as air movers, air scrubbers, dehumidifiers, etc. As will be discussed in greater detail in connection with FIGS. 11-13, the system allows a user to generate a floorplan model of a structure including rooms, openings, and various other relevant objects such as toilets, cabinets, etc. This floorplan model can be drawn by the user using the interface 110 or imported from a file, if desired. As shown in FIG. 10, the interface 110 includes a “Mitigation” pull-down tool that the user can select to begin generating a model (e.g., floorplan) of a structure. Additionally, the user can select and utilize one or more drawing and annotation tools 114 which allow the user to further define the water damage and/or mitigation model, as discussed in greater detail below.

FIG. 11 is a diagram illustrating a water damage and/or mitigation floorplan model 120 capable of being generated by the system of the present disclosure. Utilizing the tools of the user interface 110, the user can either draw the floorplan model 120 (corresponding to the floorplan of a building or structure), or import the model from a file. Once the floorplan model 120 has been created, it can be annotated to indicate areas 122, 124 where water damage exists, and/or areas where mitigation of water damage should be addressed. The areas 122, 124 are used to define the area within a property that has been damaged by the water or other contaminants. The affected areas are used in calculations and as inputs to the questions presented to the user. There are three distinct types of areas that can be defined, but of course, others are possible:

1. Floor Affected Areas: these are represented in the area 124, and can be placed in rooms in three different ways:
a. Click-and-drag to place a rectangular area. This can overlap multiple rooms, or just be in part of a single room, or anything in between.
b. Double-click in a room to place the area to cover the entire floor of the room.
c. Point-to-point: single-click once to place the starting point, then move the mouse to the next corner of the area. This method can be used to make any shape of affected area required.

2. Wall Affected Area: These can be represented in various colors and can be placed in rooms in three different ways:
a. Flood Lines can be placed by right-clicking a selected room and choosing the distance up the wall where the user wishes the flood line to be placed. This will place a flood line at the measurement listed, down to the floor, on every wall of a room.
b. Double-click on a wall surface to place an affected area that covers the entire wall surface.
c. Point-to-point: Single-click to place the starting point, then move the mouse to the next corner of the area. This method can be used to make any shape affected area required.

3. Ceiling Affected Area: These can be represented in various colors, and ceilings can be shown or hidden. Ceiling affected areas can be designated using the same methods that can be used for Floor Affected Areas.

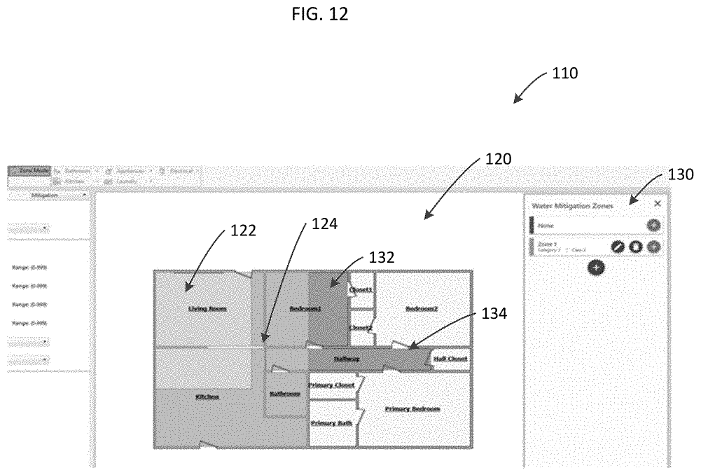

FIG. 12 is a diagram illustrating the user interface of the system of present disclosure, wherein water damage and/or mitigation zones are defined. As can be seen, the interface 110 includes the floorplan model 120, which includes various areas 122, 124, 132, and 134 indicating water damaged areas. Various water mitigation “zones” 130 can be defined and accessed by the user. Each zone is a set of rooms that received a specific type of water damage or need to be calculated differently than other rooms. Multiple rooms can be defined in a single zone. However, a room can only be part of a single zone. If two separate zones are needed in the same room, the room can be split, and the new wall marked as missing wall. The missing wall can be set to be a barrier if desired. The split rooms can also be combined so one is a subgroup of the other to keep them together as a group, but each of the split rooms can be placed in a different zone for water mitigation.

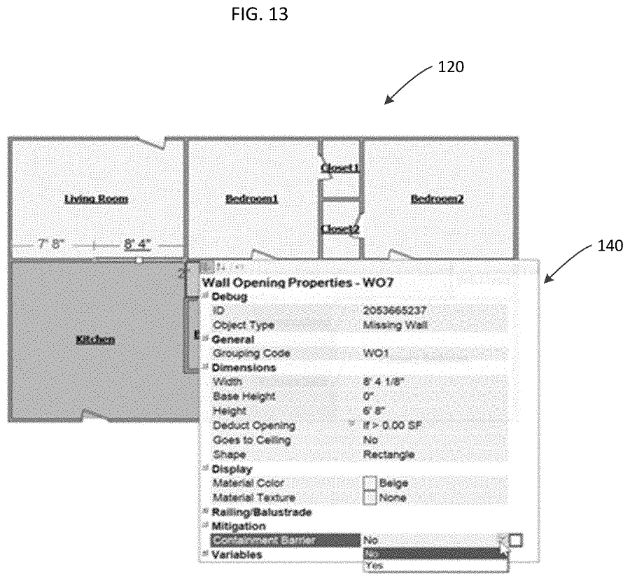

FIG. 13 is diagram illustrating a user interface tool 140 for defining barriers between water damage and/or mitigation zones of the model 120. Barriers are placed between zones to contain the environment the equipment is working in. Barriers can be set on openings between rooms such as doors or missing walls. This is done by selecting the opening and setting the barrier property.

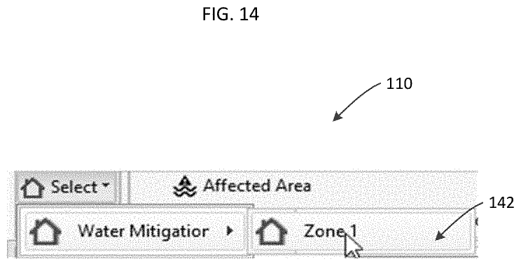

FIG. 14 is diagram illustrating a user interface tool 142 for selecting one or more water damage and/or mitigation zones of the model. The tool 142 (of the interface 110) can be pulled down by the user to select a particular zone. Once the desired zone is elected, the system automatically generates a set of questions that are presented to the user based on the objects that exist in the selected zone. The user will primarily work with selections of rooms or a zone, and the user can either manually select the room(s) for which additional information is to be specified (“scoped”), or select all rooms belonging to a particular zone (for which additional information is to be specified).

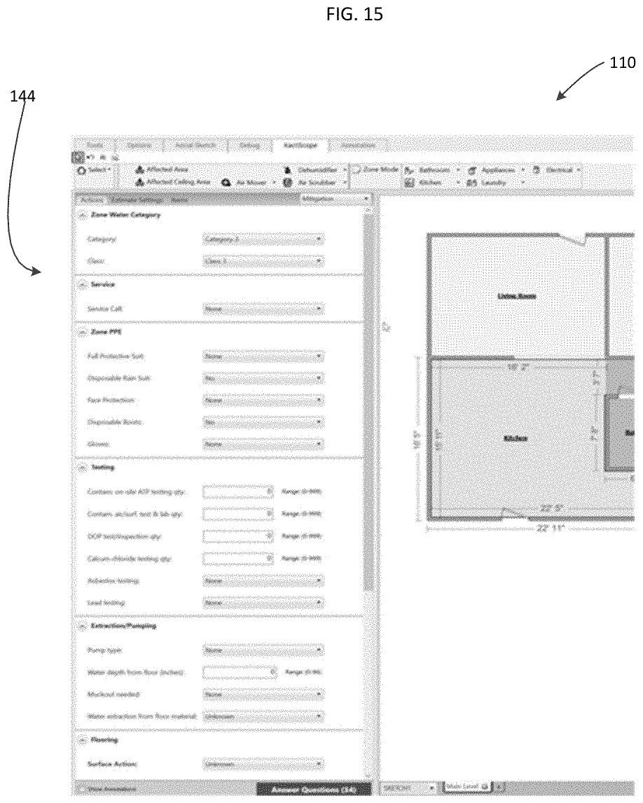

FIG. 15 is diagram illustrating a user interface tool 144 for guided capturing of information relevant to modeling of water damage and/or mitigation of a structure. The tool 144 is displayed by the interface 110, and presents a list of questions that serves as a guide or a “script” for the user to follow to ensure that the user includes include all necessary items required to generate an estimate for mitigating water damage. The script can be customized for individual customers, workflows, and industry standards. The user also can set default answers at various administrative levels to ensure end users follow a particular protocol.

The questions presented in the tool 144 can be listed in a particular order or hierarchy. The answers to higher level questions are used to determine which lower-level questions should be presented. The objects from the floorplan and other calculations also limit the questions to only those that are relevant. This automates and simplifies the workflow for the user and makes it significantly more efficient. A non-limiting example of or a typical set of the types of questions a user would be presented by the system for water mitigation is as follows:
Category and Class of Water (May also been set earlier in the zone creation). These determine some of the types of cleaning, equipment, and labor that will be needed in the subsequent questions.
Service Calls
Zone PPE (Personal Protective Equipment)
Testing
Extraction Pumping
Flooring
Walls
Baseboards
Containment/Coverings/Barriers
Ducting
Monitoring/Setup/Decontamination
   The user works down the list presented in the tool 144, answering each question presented in the tool 144. As this occurs, a set of line items is generated based on those answers.

Optionally, a user can allow the script to guide them to questions that require an answer to complete the items list. When the “Answer Questions” button at the bottom of the Script Pane is red, this means there are remaining unanswered questions. The numerical value in parentheses indicates the number of unanswered questions remaining. Clicking this button will automatically change the selection as necessary and take the user to the next unanswered question. Note that often, answering a single question will reduce the unanswered questions by more than one, because the answer given is applied to multiple objects. For example, answering the Floor Surface Action for 6 rooms will reduce the total unanswered questions by 6. Also note that occasionally, answering an unanswered question will cause other questions to appear, depending on the answer given. A user should expect the number of unanswered questions to fluctuate up and down as they work until all questions are answered.

With most water mitigation projects, various environmental and other data is collected from the property. This may be moisture saturation readings from various materials, water depth, interior/exterior humidity and temperature, etc. These readings are taken at the beginning of the mitigation, then taken at various intervals throughout the project to establish a baseline and then verify the mitigation is working and on track. The tools described herein can allow users to graphically place an object in the model (e.g., floorplan 120) to represent the location, type, date, time, and values for those readings. These readings can be used as inputs to the various calculations for what equipment or other actions are needed. Various reports can also be made available, based the on the collected data readings, equipment, and other actions taken as part of the mitigation project.

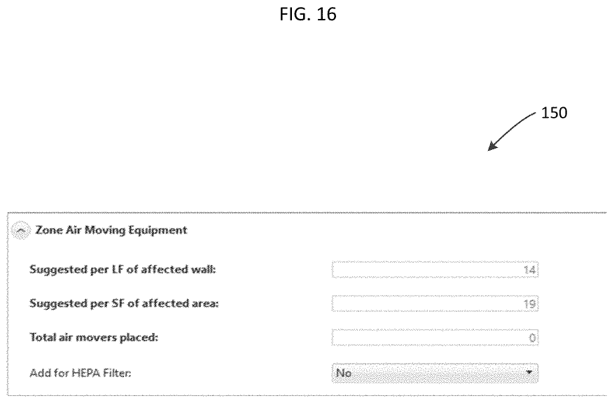

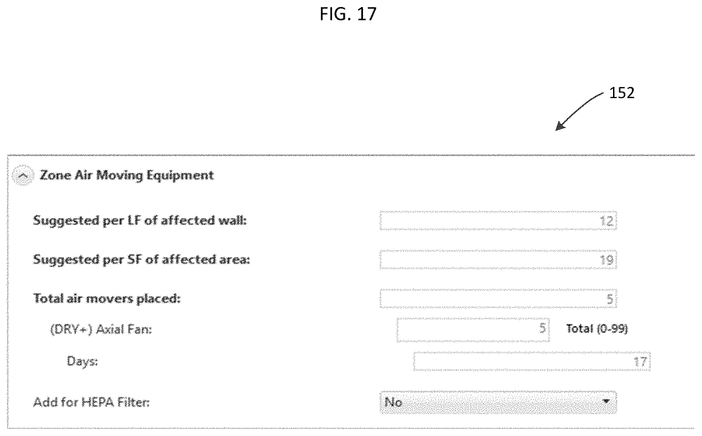

FIGS. 16-17 are diagrams illustrating user interface tools or “cards” 150, 152 for performing calculations for equipment relating to water damage and/or mitigation of a structure. The affected areas, surface area, the shape of the room(s), the existing offsets within those room(s), and other factors are used as inputs to the calculations. A suggested quantity is provided in the various equipment sections of the questions. These calculations follow industry standards such as the IIRC S500 rules. For example, suggested number of Air Movers is provided in the Zone Air Moving Equipment card shown in tools 150, 152 of FIGS. 16-17. These calculated suggestions can be used to guide the user to add the necessary equipment. Tools are provided for the user to graphically place specific equipment objects in the floorplan model, showing any relevant orientations, in the configuration they deem best. As these objects are placed, the questions are updated to reflect the amount of equipment placed, allowing the user to compare it to the suggested amounts. Equipment can be given an individual number of days that item will operating in the room. The total days of equipment is shown in the card 152 of FIG. 17. Additionally, the cards 150, 152 could automatically place the equipment in the floorplan model, using inputs and rules to determine optimal locations based on the specific geometry of the rooms and other objects in the floorplan model.

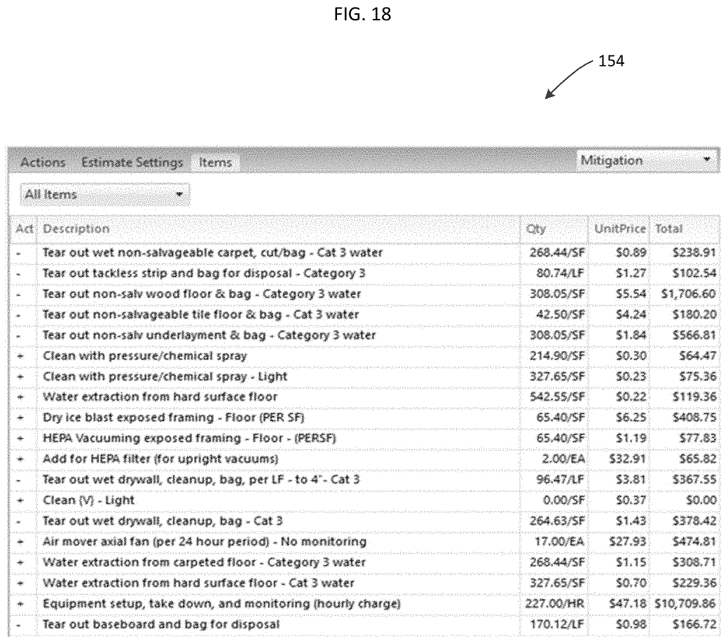

FIG. 18 is a diagram illustrating a report 154 generated by the system listing tasks and associated costs for mitigating water damage of a structure as modeled by the system. As each question is answered, the list 154 is generated. Once complete, the list 154 can be exported into the estimate by clicking the Add Items button. If any answers are changed a new list will be generated, and those items will be replaced with the new set only if the Add Items button is clicked again. Selecting an item will highlight where in the floorplan model the item applies. This provides an easy way for users or other reviewers to validate that the items are placed correctly.

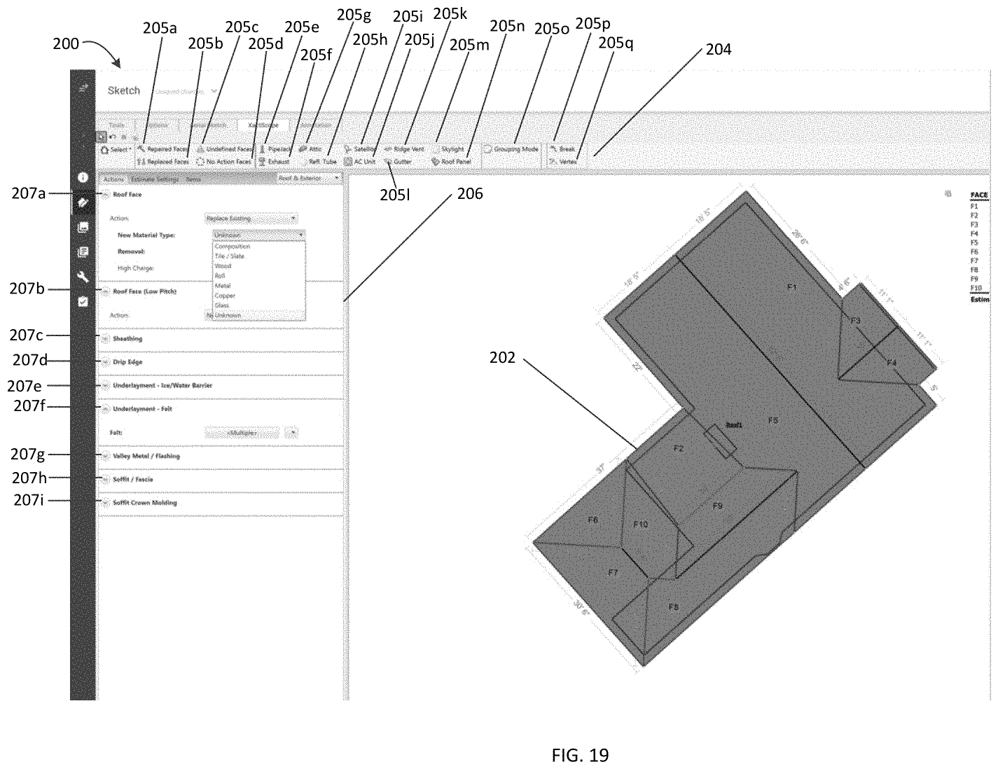

The systems and methods disclosed herein could be extended to allow a user to rapidly develop an annotated computer model of a roof and/or exterior of a structure to generate an estimate for the repair thereof and/or an annotated computer model of an interior (e.g., a floorplan) of a structure to mitigate and/or model water damage thereof, as well as generate tasks and costs associated with mitigating such damage. In particular, an interface screen displayed by a unified user interface can present a list of questions associated with roof and exterior pull down tools or mitigation pull down tools that serve as a guide or a “script” for the user to follow to ensure that the user includes all necessary items and information required to generate an estimate for repairing a roof and/or exterior of a structure and/or mitigating water damage of the structure. These scripts are automated and assisted estimating tools that can be stored in and accessed from a database such that the scripts can be utilized by but are not hard coded into the XACTIMATE software package. Therefore, the scripts can be updated without updating the XACTIMATE software package. The systems and methods disclosed herein can utilize a combination of a model variable (e.g., a reference area, a reference point and a reference line) mapped to line items in the XACTIMATE software package, a script that follows a specific workflow utilizing construction logic and order of operation within a given workflow, and user profile defaults determined and set by a user to narrow and enumerate a number of questions and/or options that are consistent with the user's specific best practices and preferences. The systems and methods disclosed herein provide for a user to quickly and efficiently annotate a model with objects and/or data, utilize any model object created by the user or imported by an approved third party, and draft an estimate. It should be understood that the while the systems and methods disclosed herein can automate the estimate drafting process, a user can change any item of the estimate and/or automated response so long as the change is possible within construction logic. Such embodiments of the system will now be disclosed in connection with FIGS. 19-27.

FIGS. 19-21 are diagrams and screenshots illustrating an embodiment of the system of the present disclosure for rapidly developing an annotated computer model of a roof and/or exterior of a structure to generate an estimate for the repair thereof. In particular, FIG. 19 is a screenshot illustrating a unified user interface 200 generated by the system, wherein an annotated computer model 202 of a structure can be generated. The unified user interface 200 allows a user to interact in a single user interface with a 2D or 3D model 202 of a structure (e.g., a roof structure). As shown in FIG. 19, the unified user interface 200 can include a toolbar 204 including drawing and annotation tools 205a-q which allow a user to draw and annotate the model 202 and an interface screen 206 including roof and exterior pull down tools 207a-i which allow the user to annotate the model 202 and specify information about objects of the model 202 using targeted responses to questions automatically generated by the system. It should be understood that the unified user interface 200 can support any model including imported models by authorized third parties, convert a block format model to a wireframe model, annotate objects of the model, and support various roofing material types including commercial roofing materials.

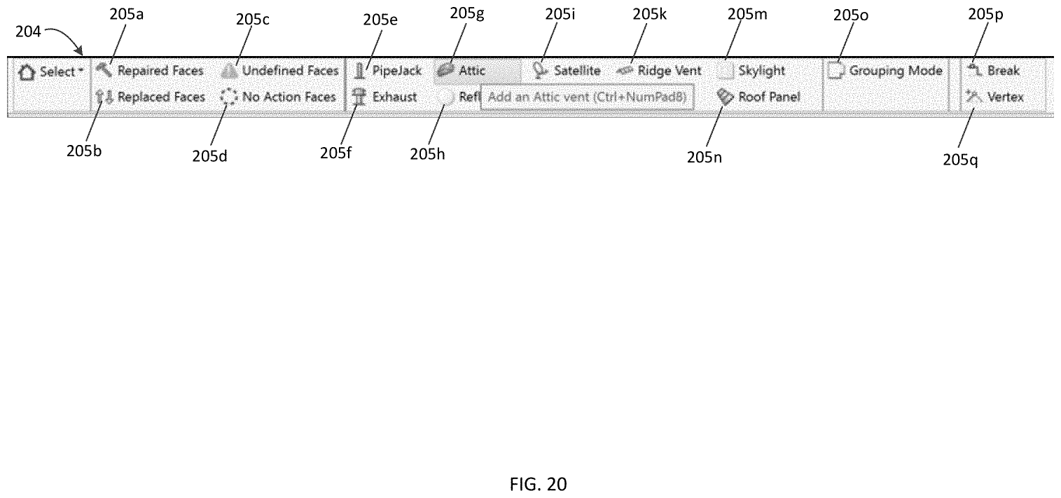

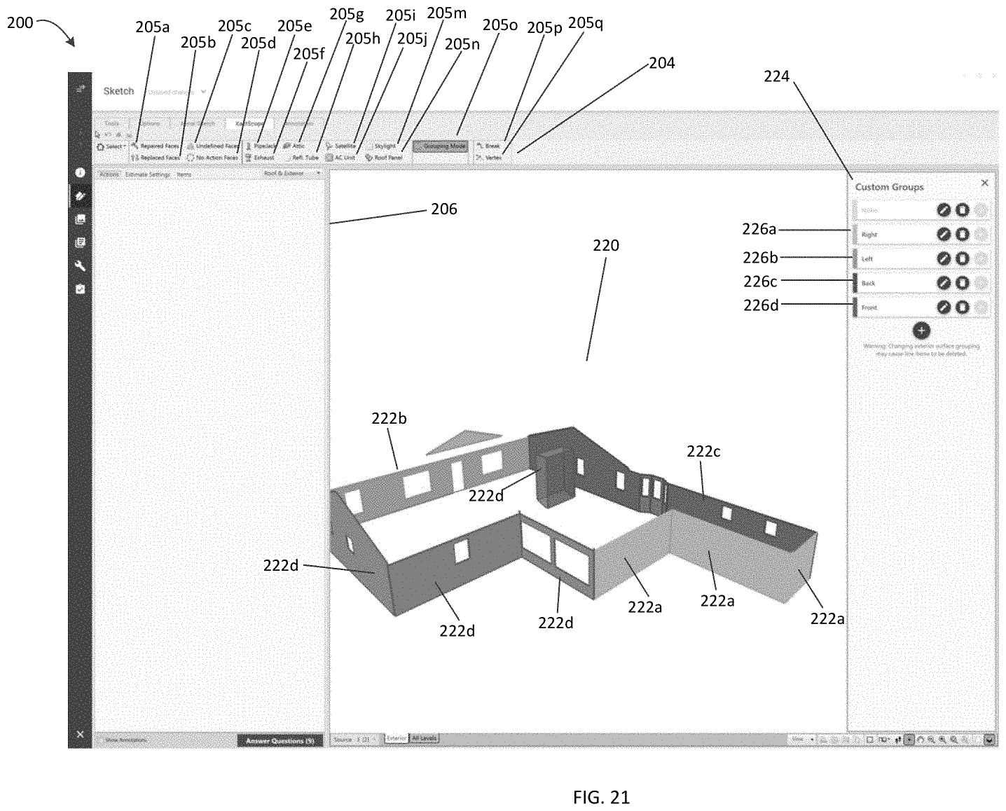

The model 202 can be drawn by the user using the unified interface 200 or imported from a file, if desired. A user can select and utilize one or more drawing and annotation tools 205a-q of the toolbar 204 which allow the user to annotate the model 202. The toolbar 204 can include drawing and annotation tools such as, but not limited to, a repaired faces tool 205a, a replaced faces tool 205b, an undefined faces tool 205c, a no action faces tool 205d, a pipejack tool 205e, an exhaust tool 205f, an attic vent tool 205g, a reflective tube tool 205h, a satellite tool 205i, an air condition (AC) unit tool 205j, a ridge vent tool 205k, a gutter tool 205l, a skylight tool 205m, a roof panel tool 205n, a grouping mode tool 205o, a break tool 205p, and a vertex tool 205q. The user can annotate faces of the model 202 via one or more of the repaired faces tool 205a, the replaced faces tool 205b, the undefined faces tool 205c, and the no action faces tool 205d to respectively indicate whether the faces of the model 202 are one or more of repaired faces, replaced faces, undefined faces and/or no action faces. Additionally, the user can annotate faces of the model 202 via one or more of the drawing and annotation tools 205e-n to respectively add and position one or more of a pipejack, exhaust, attic vent, reflective tube, satellite, AC unit, ridge vent, gutter, skylight and/or roof panel to one or more faces of the model 202. For example, FIG. 20 is a diagram illustrating the toolbar 204 of the unified user interface 200 of FIG. 19, where a user can click on or input a shortcut key (e.g., Ctrl+NumPad8) to select the attic tool 205g to add an attic vent to one or more faces of the model 202. As described in further detail below with respect to FIG. 21, the user can utilize the grouping mode tool 205o to group exterior surfaces of a model, the break tool 205p to split exterior surfaces of a model into multiple surfaces and the vertex tool 205q to create a vertex between adjacent surfaces of a model.

Additionally, a user can select and utilize one or more roof and exterior pull down tools 207a-i of the user interface screen 206 for specifying information about objects of the model 202 using targeted responses to questions automatically generated by the system. The roof and exterior pull down tools can include, but are not limited to, a roof face tool 207a, a low pitch roof face tool 207b, a sheathing tool 207c, a drip edge tool 207d, an ice/water barrier underlayment tool 207e, a felt underlayment tool 207f, a valley metal/flashing tool 207g, a soffit/fascia tool 207h and a soffit crown molding tool 207i. Each answer to a question provided by the user (e.g., by changing selections of the pull-down prompts in response to associated questions) cycles the process back to regenerating the questions dynamically, thus providing a rich user interface which elicits the most relevant information from the user related to objects in the model 202. The process continues iteratively until the user has picked an answer for each question for each object (such that multiple objects can be selected at once). In so doing, the system allows for the rapid generation of annotated computer models of structures and property. For example and as shown in FIG. 19, a user can select the roof face tool 207a to take an action with respect to a roof face such as replacing the existing roof face. In response to the action, the system can generate a plurality of new material types (e.g., composition, tile/slate, wood, roll, metal, copper, glass or unknown) to be selected by the user for replacing the existing roof face.

FIG. 21 is another screenshot illustrating the unified user interface 200 generated by the system of the present disclosure. As shown in FIG. 21, the unified user interface 200 can include the toolbar 204 including drawing and annotation tools 205a-q, the interface screen 206, and a customizable group interface screen 224 which allows a user to group at least one exterior surface of a model 220 and/or object contained therein with a respective orientation of the model 220 in connection with the grouping mode tool 205o of the toolbar 204. For example, the user can group exterior surfaces 222a with a right side 226a of the model 220, exterior surface 222b with a left side 226b of the model 220, exterior surface 222c with a back side 226c of the model 220 and exterior surfaces 222d and object 222d with a front side 226d of the model 220. It should be understood that the unified user interface 200 can support any model including imported models by authorized third parties, add exterior line items to a grouped elevation folder, split exterior surfaces into multiple surfaces (e.g., by utilizing the break tool 205p), and identify and support a variety of exterior surfaces and the features thereof (e.g., a window and door).

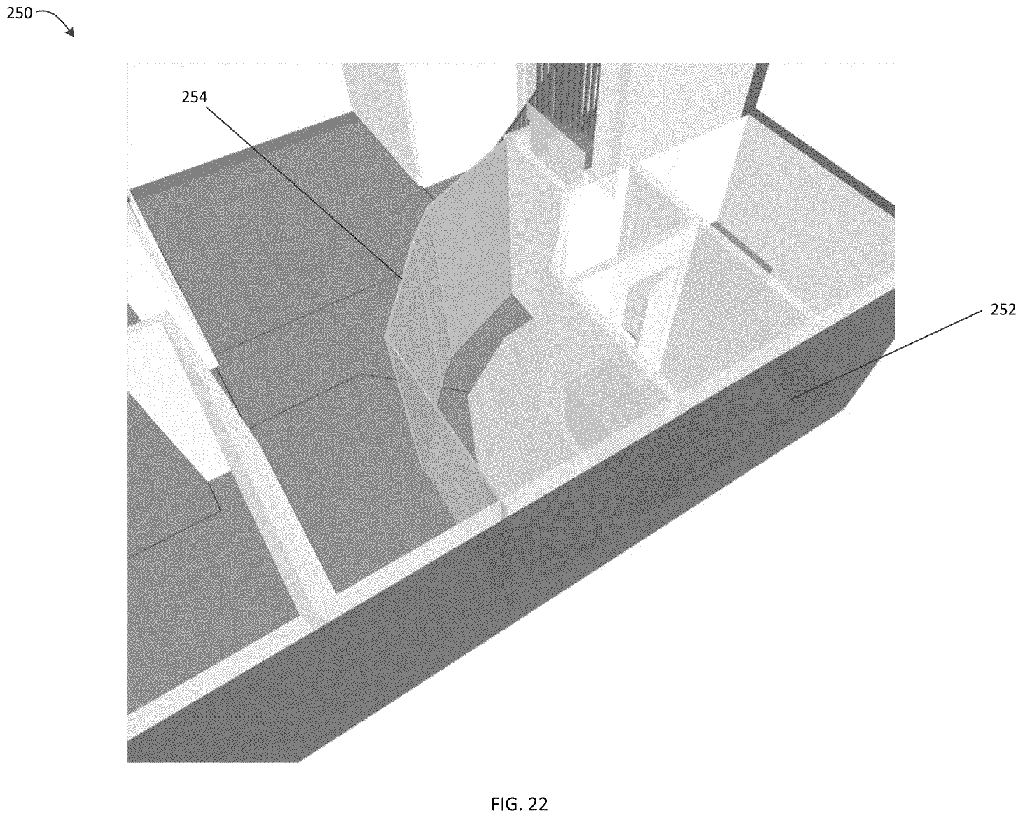

FIGS. 22-27 are diagrams and screenshots illustrating an embodiment of the system of the present disclosure for rapidly developing an annotated computer model of an interior (e.g., a floorplan) of a structure to mitigate and/or model water damage thereof, as well as generate tasks and costs associated with mitigating such damage. In particular, FIG. 22 is a diagram 250 illustrating a mitigation barrier 254 that can be created in a model 252 generated by the system of the present disclosure. The barrier 254 can be positioned between water damage and/or mitigation zones of the model 252 and the system can automate line items required for the construction of the barrier 254. The barrier 254 can be utilized to contain water damage and/or an environment mitigation equipment (e.g., an air mover, a dehumidifier, or an air scrubber) is operating in, and as such, can provide for limiting calculations to mitigate water damage by mitigation equipment to a defined area. The barrier 254 can also be positioned in the model 252 to separate an area for the containment of hazardous materials (e.g., chemicals). As shown in FIG. 22, the barrier 254 can be positioned in an opening between rooms such as doors or missing walls. This is done by selecting the opening and setting the barrier property.

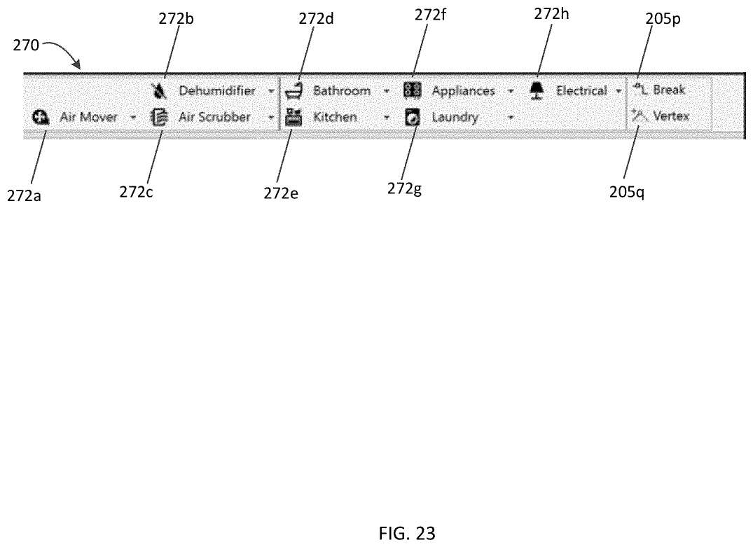

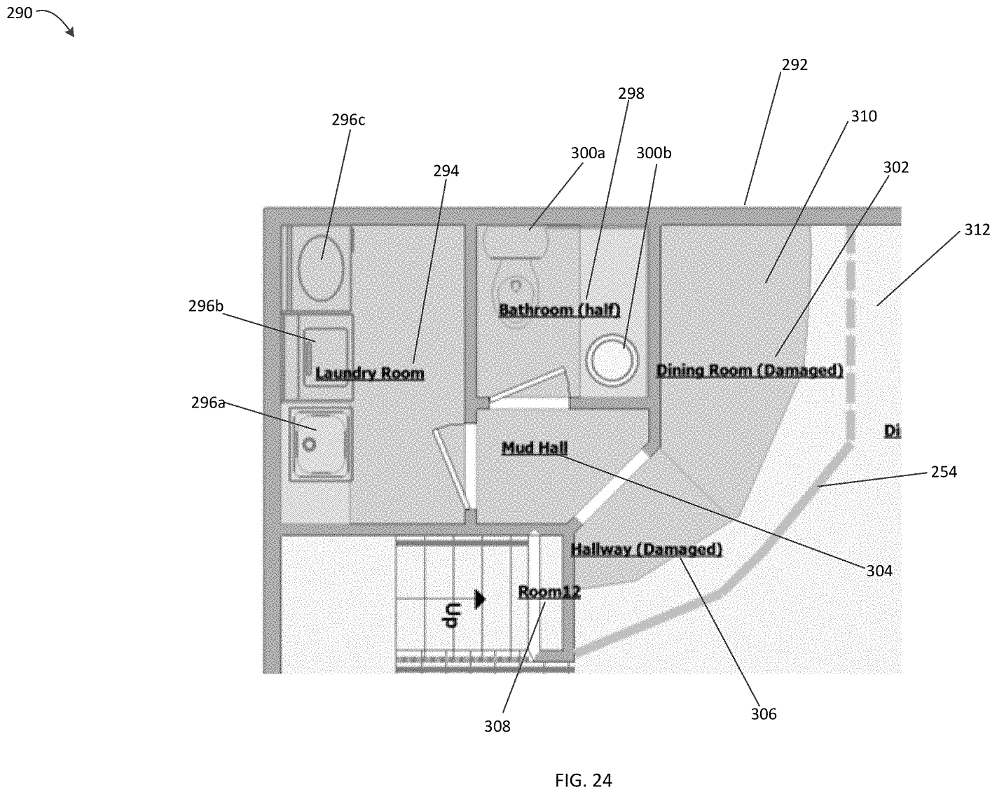

FIG. 23 is diagram illustrating a toolbar 270 for generating a floorplan of a model and selecting and positioning one or more objects in the floorplan of the model (e.g., water damage and/or mitigation zones of the model). As shown in FIG. 23, the toolbar 270 can include objects and tools such as, but not limited to, an air mover object 272a, a dehumidifier object 272b, an air scrubber object 272c, a bathroom object 272d, a kitchen object 272e, an appliances object 272f, a laundry object 272g, an electrical fixtures object 272h, the break tool 205p, and the vertex tool 205q. The system allows a user to select and position objects required for water mitigation in a floorplan of a model. For example, a user can select the air mover 272a, the dehumidifier 272b, and the air scrubber 272c objects to respectively position one or more of an air mover, a dehumidifier, and an air scrubber in the floorplan of the model. Once an object is positioned, the system can assign the object a unique identification to prompt actions and/or questions with respect to the object. As will be discussed in greater detail below in connection with FIGS. 24, 26 and 27, the system allows a user to generate a floorplan of a model of a structure including rooms, openings, and various other relevant objects (e.g., equipment, toilets, cabinets, appliances, etc.).

FIG. 24 is a diagram 290 illustrating a floorplan 292 of the model 252 of FIG. 22 capable of being generated by the system. The floorplan 292 can be drawn by a user utilizing the unified user interface 200 and the toolbar 270 or imported from a file, if desired. As shown in FIG. 24, the floorplan 292 includes a laundry room 294, a half bathroom 298, a dining room 302, a mud hall 304, a hallway 306, a room 308 including a set of stairs, and the mitigation barrier 254 and indicates a water damaged area 310 and an undamaged area 312 of the floorplan 292. As mentioned with respect to FIG. 23, a user can utilize the toolbar 270 to select and position objects in a floorplan. For example, a user can select the bathroom object 272d to position a sink 296a in the laundry room 294 and can select the laundry object 272g to position a washing machine 296b and a dryer 296c in the laundry room 294. Additionally, a user can select the bathroom object 272d to position a toilet 300a and a sink 300b in the half bathroom 298.

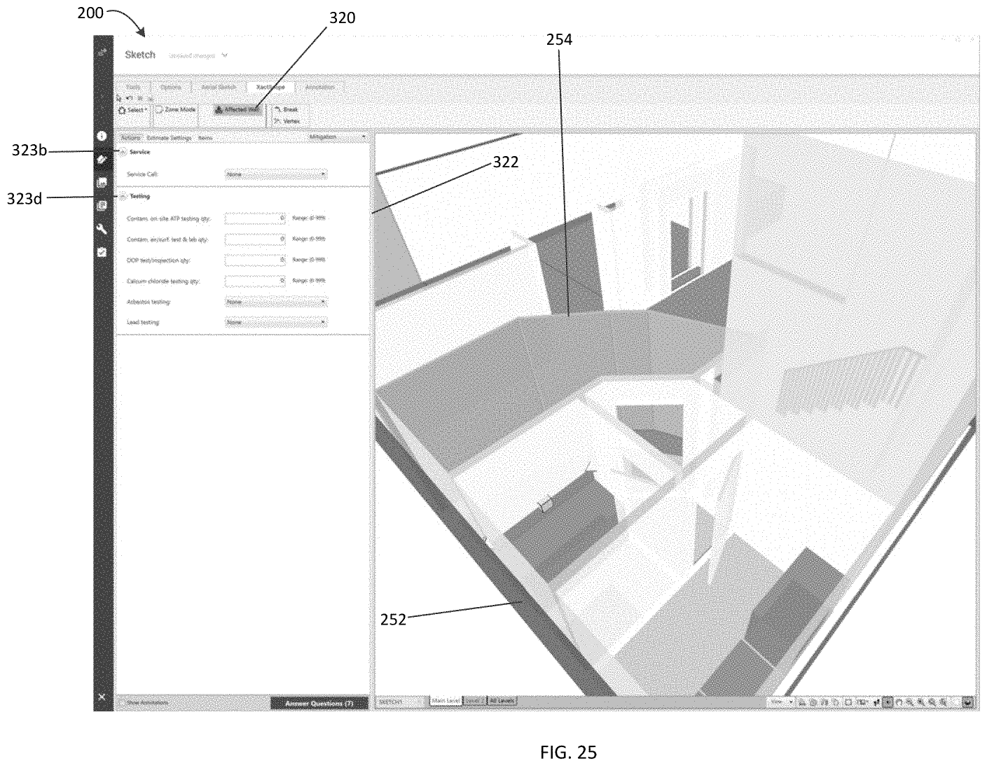

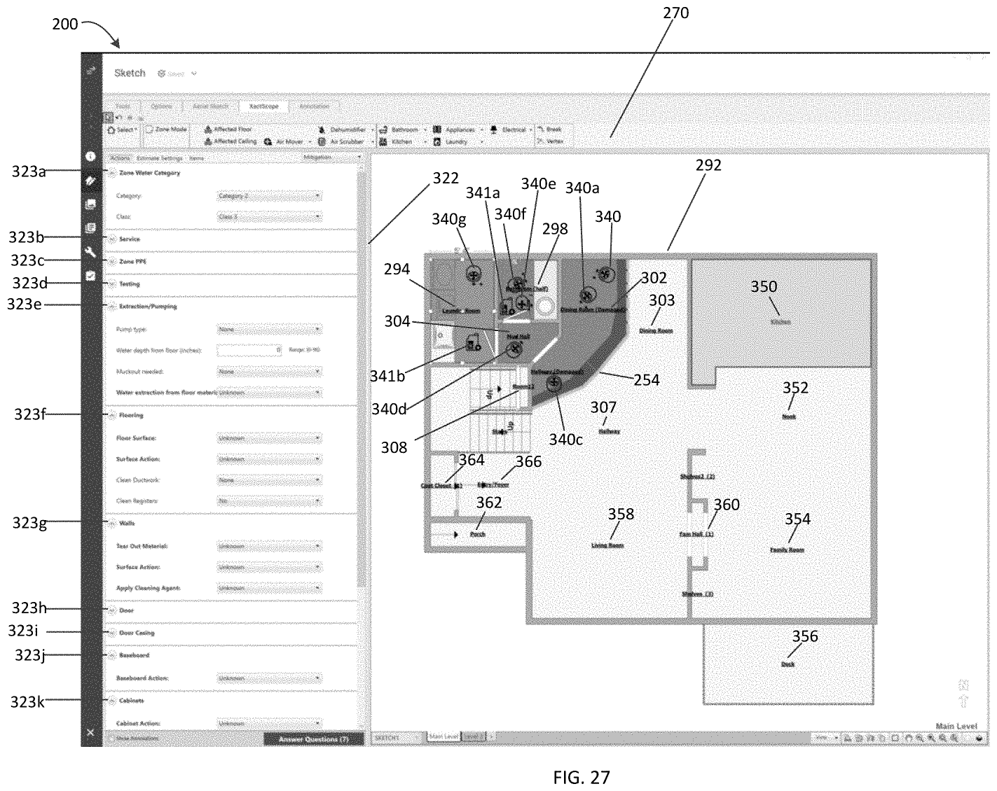

FIG. 25 is another screenshot illustrating the unified user interface 200 generated by the system of the present disclosure wherein information relevant to water damage and/or mitigation of a wall of a model can be captured. As shown in FIG. 25, the unified user interface 200 can include an affected wall tool 320 and an interface screen 322. The affected wall tool 320 allows a user to define and select a feature of a room (e.g., a floor, a ceiling, or a wall) affected by water damage and the interface screen 322 can include mitigation pull down tools 323a-k (as shown in greater detail in FIG. 27) for specifying and capturing information regarding an affected wall of the model 252 using targeted responses to questions automatically generated by the system. For example, a user can utilize the affected wall tool 320 to select the barrier 254 and utilize the service tool 323b and the testing tool 323d to respectively generate a service call regarding the barrier 254 and capture testing data of the barrier 254 based on properties of the water associated with water damage to the barrier 254. The system also provides from performing calculations to determine a number of air movers to mitigate the water damage of an affected wall.

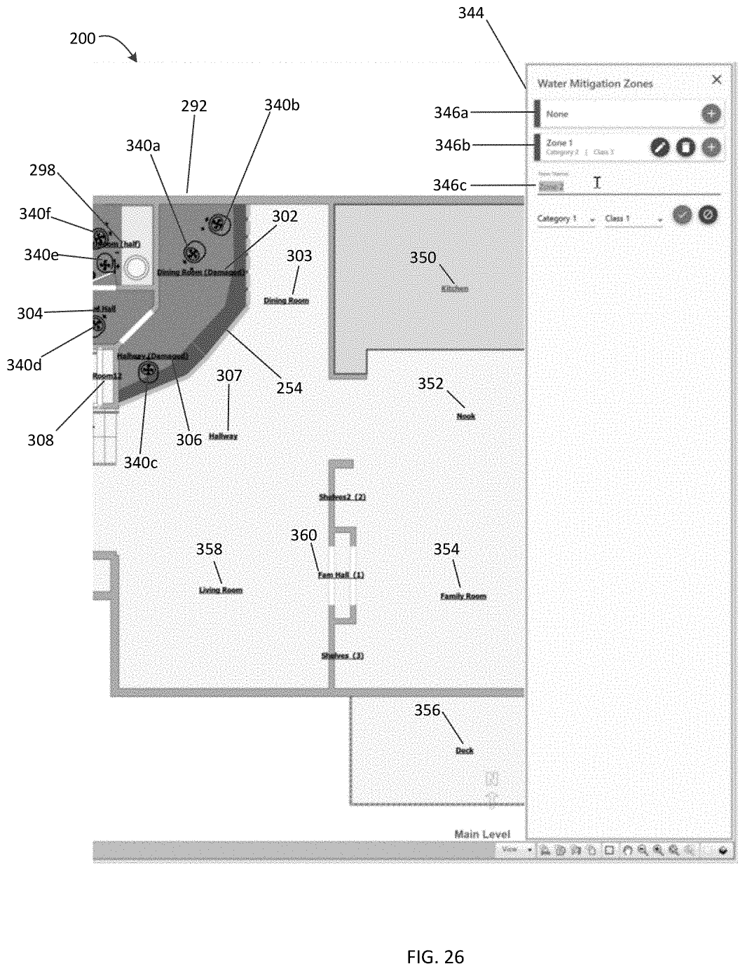

FIG. 26 is another screenshot illustrating the unified user interface 200 of the system of present disclosure, wherein water damage and/or mitigation zones can be defined. As shown in FIG. 26, the unified user interface 200 includes an expanded version of the floorplan 292 of FIG. 24 including various rooms and the mitigation barrier 254 and a water mitigation zone interface screen 344. Various water mitigation zones having a category and class can be defined and accessed by a user. Each zone is indicative of an area (e.g., a room or set of rooms) that has received a specific type of water damage and/or requires a unique calculation to mitigate the water damage via mitigation equipment (e.g., air movers 340a-f). Each zone can be defined based on one or more of a water type (e.g., salt, potable, sewage, etc.) effecting the damage, a material (e.g., wood, tile, carpet, concrete, drywall, etc.) the water has affected, and air control movement.

Multiple rooms can be defined in a single zone. However, a room can only be part of a single zone. If two separate zones are needed in the same room, the room can be split by adding a wall, and the new wall can be marked as a missing wall. The missing wall can be set to be a barrier if desired. For example, the barrier 254 respectively divides the dining room and hallway into damaged portions 302, 306 and undamaged portions 303, 307 where the undamaged dining room portion 303 and the undamaged hallway portion 307 comprise a part of no zone 346a (e.g., none) and the damaged dining room portion 302 and the damaged hallway portion 306 comprise a part of zone one 346b having category two and class three water damage. Split rooms can also be combined so one is a subgroup of the other to keep them together as a group, but each of the split rooms can be placed in a different zone for water mitigation.

As shown in FIG. 26, the undamaged dining room portion 303, the undamaged hallway portion 307, a room 308, a nook 352, a family room 354, a deck 356, a living room 358 and a family hall 360 define the no zone 346a and a damaged half bathroom 298, the damaged dining room portion 302, a damaged mud hall 304, and the damaged hall portion 306 define zone one 346b having category 2 and class 3 water damage. As mentioned above with respect to FIG. 23, the system allows a user to select and position objects required for water mitigation in a floorplan of a model. For example, a user can select the air mover object 272a of the toolbar 270 (as shown in FIG. 23) to respectively position each of the air movers 340a-f in zone one 346a of the floorplan 292 to mitigate the water damage thereof. FIG. 26 also illustrates the creation of zone two 346c having category one and class one water damage where a kitchen 350 defines zone two 346c.

FIG. 27 is another screenshot illustrating the unified user interface 200 generated by the system of the present disclosure, wherein information relevant to water damage and/or mitigation can be captured. As shown in FIG. 27, the unified user interface 200 can include the toolbar 270, the floorplan 292, and the interface screen 322 including mitigation pull down tools 323a-k for specifying and capturing information regarding an affected area of the floorplan 292 using targeted responses to questions automatically generated by the system. The mitigation pull down tools can include, but are not limited to, a zone water category tool 323a, the service tool 323b (as shown in FIG. 25), a zone personal protective equipment (PPE) tool 323, the testing tool 324d (as shown in FIG. 25), an extraction/pumping tool 323e, a flooring tool 323f, a walls tool 323g, a door tool 323h, a door casing tool 323i, and baseboard tool 323j, and a cabinets tool 323k.

The interface screen 322 presents a list of questions associated with each of the mitigation pull down tools 323a-k that serves as a guide or a “script” for the user to follow to ensure that the user includes include all necessary items required to generate an estimate for mitigating water damage. The script can be customized for administrators, individual customers, workflows, and industry standards. The user also can set default answers at various administrative levels to ensure end users follow a particular protocol. The questions presented in the interface screen 322 can be listed in a particular order or hierarchy. The answers to higher level questions can be used to determine which lower-level questions should be presented. For example, the category and class of water damage of the zone water category tool 323a can determine some of the types of cleaning, equipment, and labor that will be needed in the subsequent questions. The objects of the floorplan 292 and other calculations also limit the questions to only those that are relevant. The user works down each of the mitigation tools 323a-k presented in the interface screen 322, answering each question presented in the interface screen 322. As this occurs, a set of line items is generated based on those answers.

Optionally, a user can allow the script to guide them to questions that require an answer to complete the items list. When the “Answer Questions” button at the bottom of the interface screen 322 is red, this means there are remaining unanswered questions. The numerical value in parentheses indicates the number of unanswered questions remaining. Clicking this button will automatically change the selection as necessary and take the user to the next unanswered question. Note that often, answering a single question will reduce the unanswered questions by more than one, because the answer given is applied to multiple objects. For example, answering the Floor Surface Action question of the flooring tool 323f for 6 rooms will reduce the total unanswered questions by 6. Also note that occasionally, answering an unanswered question will cause other questions to appear, depending on the answer given. A user should expect the number of unanswered questions to fluctuate up and down as they work until all questions are answered.

With most water mitigation projects, various environmental and other data is collected from the property. This may be moisture saturation readings from various materials, water depth, interior/exterior humidity and temperature, etc. These readings are taken at the beginning of the mitigation, then taken at various intervals throughout the project to establish a baseline and then verify the mitigation is working and on track. As described above with respect to FIG. 23, the toolbar 270 can allow a user to graphically position an object (e.g., mitigation equipment) including, but not limited to, an air mover, a dehumidifier and an air scrubber in a floorplan of a model. For example, air movers 340a-g and air scrubbers 341a-b are positioned in the floorplan 292 of the model 252. Once an object is positioned, the system can assign the object a unique identification to prompt actions (e.g., readings and the values thereof) and/or questions with respect to the object such as a location and type of the object, date, and time. As such, an object can provide one or more water mitigation reference points based on the readings thereof, including, but not limited to, hours of operation, days of use, pints of water extracted, affected area climate, non-affected area climate, exterior climate, temperature, relative humidity, grains per pound, and saturation percentage. These readings can be used as inputs to the various calculations for what equipment or other actions are needed (e.g., adding and positioning specified mitigation equipment in a floorplan). Various reports and reporting formats can also be made available, based the on the collected data readings, equipment, and other actions taken as part of the mitigation project. For example, the system can generate a tabular report based on readings for a predetermined number of days with respect to water mitigation zones and affected areas.

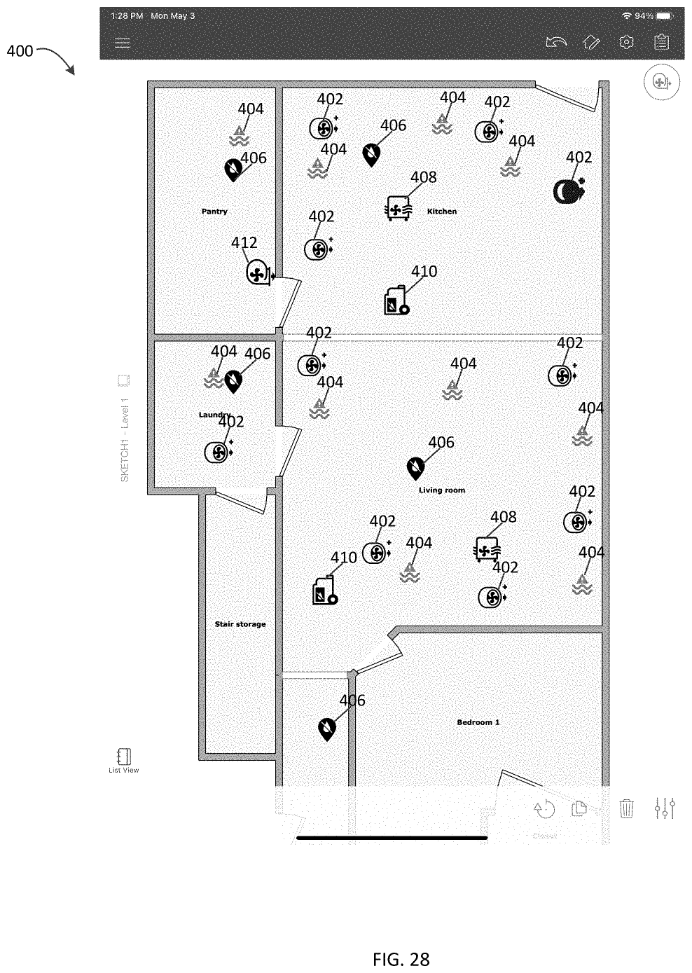

FIGS. 28-31 are diagrams illustrating additional user interface screen generated by the system of the present disclosure, wherein information relating to placement and operational status of various water mitigation equipment can be graphically accessed and managed. As shown in FIG. 28, user interface screen 400 allows a user to place a plurality of icons 402-412 at various locations on a floorplan of a structure, to indicate the locations of various water mitigation equipment physical located within the structure, as well as to log, access, and manage, information relating to water mitigation efforts being undertaken within the structure in order to mitigate water damage. The icons 402-412 could include, but are not limited to, air mover icons 402, moisture log icons 404, temperature and humidity tracking icons 406, dehumidifier icons 408, miscellaneous equipment icons 410, and blower icons 412. Advantageously, the user can place the icons 402-412 at desired locations by dragging and dropping the icons 402-412 on top of the floorplan shown in FIG. 28. Moreover, information relating to operation of various equipment corresponding to the icons 402-412 (such as air movers, blowers, dehumidifiers, etc.) can easily be accessed by clicking on the icons 402-412, whereupon the information is presented in “fly-out” user interface screens as will be discussed in greater detail below.

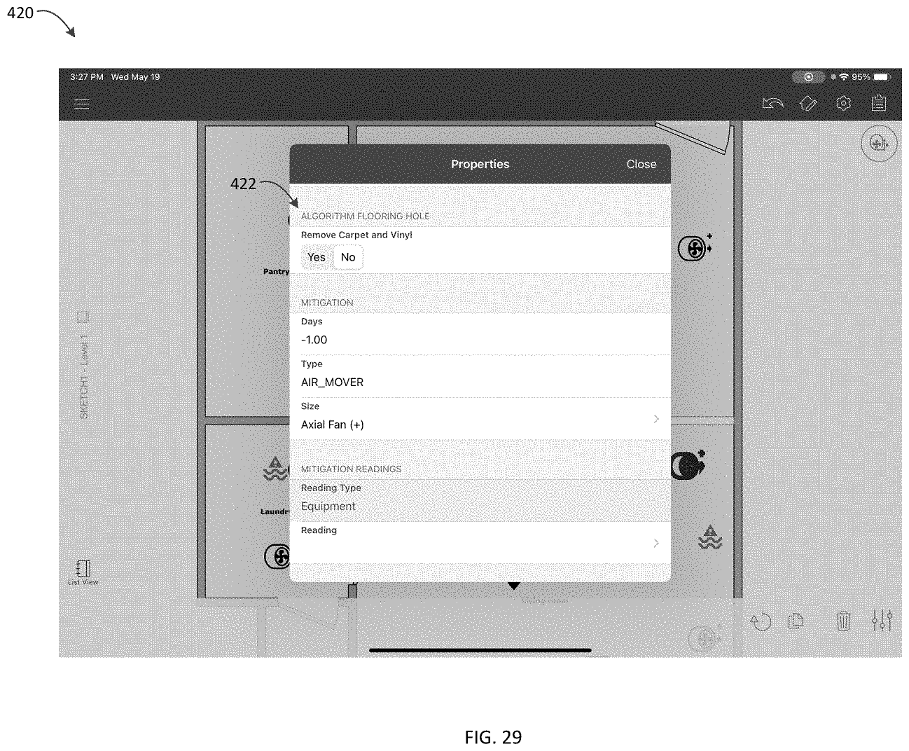

FIG. 29 is a diagram 420 illustrating an air mover information fly-out user interface screen 422 displayed by the system when the user clicks on one of the air mover icons 420 shown in FIG. 28. In the screen 422, detailed information is provided to the user relating to parameters and/or operation of a specific air mover corresponding the icon 402 clicked on by the user. As can be seen, the information includes, but is not related to, the number of days of operation of the air mover, the type of air mover, the size of the air mover, various readings relating to operation and/or performance of the air mover, and an indication of whether carpeting and/or vinyl was removed in the room in which the air mover is located. The information provided in the screen 422 could be manually entered by the user (e.g., by an insurance adjuster or water technician investigating the structure), or automatically (e.g., the information could be automatically transmitted to the system from the air mover over one or more wired or wireless data links, and the screen 422 could automatically be populated with the information and stored in a database, providing real-time status information corresponding to the air mover). Additionally, it is noted that the information displayed in the screen 422 could automatically be propagated to other screens displayed by the system, so as to increase the speed with which information relating to water mitigation components and/or activities in a given structure can be captured.

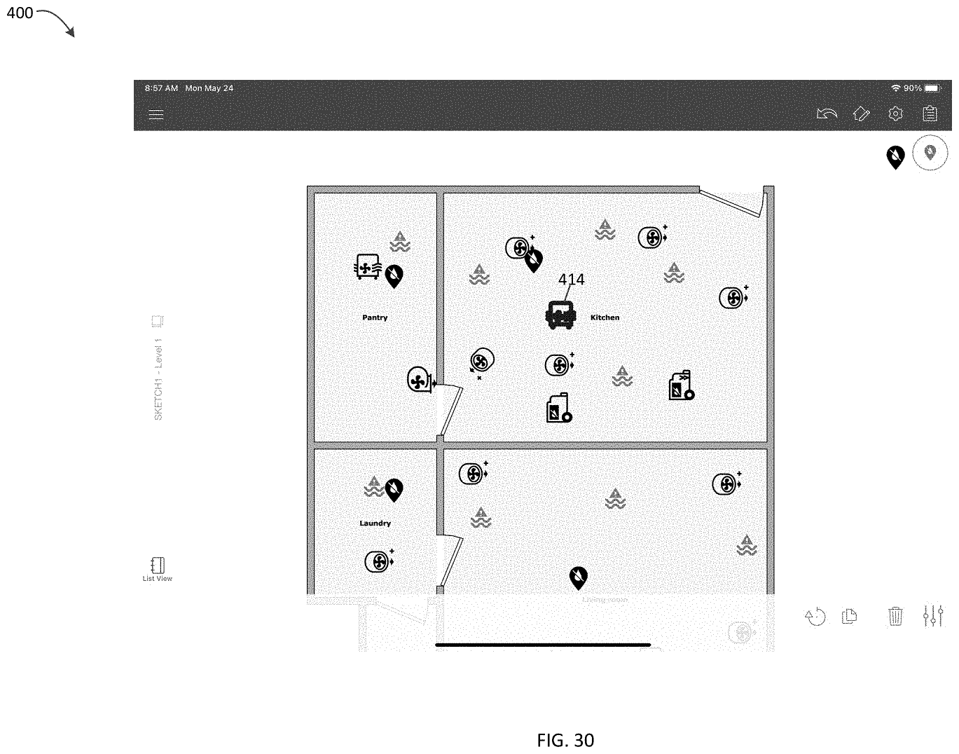

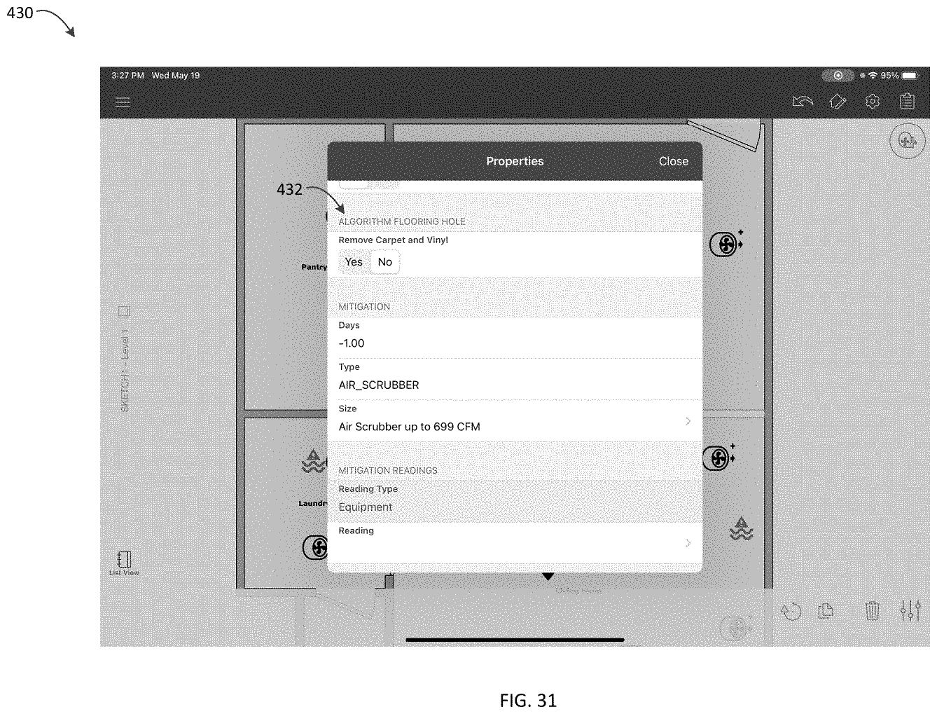

As shown in FIG. 30, the user can click on another icon corresponding to another type of air handling equipment, such as air scrubber icon 414 which corresponds to an air scrubber operating within a room shown on the floorplan of the structure. The scrubber icon 414 could be positioned by the user at a desired location on the floorplan (e.g., generally corresponding to the location where the air scrubber is located within a room). When the user clicks on the scrubber icon 414, the information fly-out screen 432 shown in the diagram 430 of FIG. 31 is displayed. As can be seen, the information includes, but is not related to, the number of days of operation of the air scrubber, the type of air scrubber, the size of the air scrubber (e.g., 699 cubic feet per minute (CFM) air flow), various readings relating to operation and/or performance of the air scrubber, and an indication of whether carpeting and/or vinyl was removed in the room in which the air scrubber is located. The information provided in the screen 432 could be manually entered by the user (e.g., by an insurance adjuster investigating the structure), or automatically (e.g., the information could be automatically transmitted to the system from the air scrubber over one or more wired or wireless data links, and the screen 432 could automatically be populated with the information and stored in a database, providing real-time status information corresponding to the air scrubber). Additionally, it is noted that the information displayed in the screen 432 could automatically be propagated to other screens displayed by the system, so as to increase the speed with which information relating to water mitigation components and/or activities in a given structure can be captured.

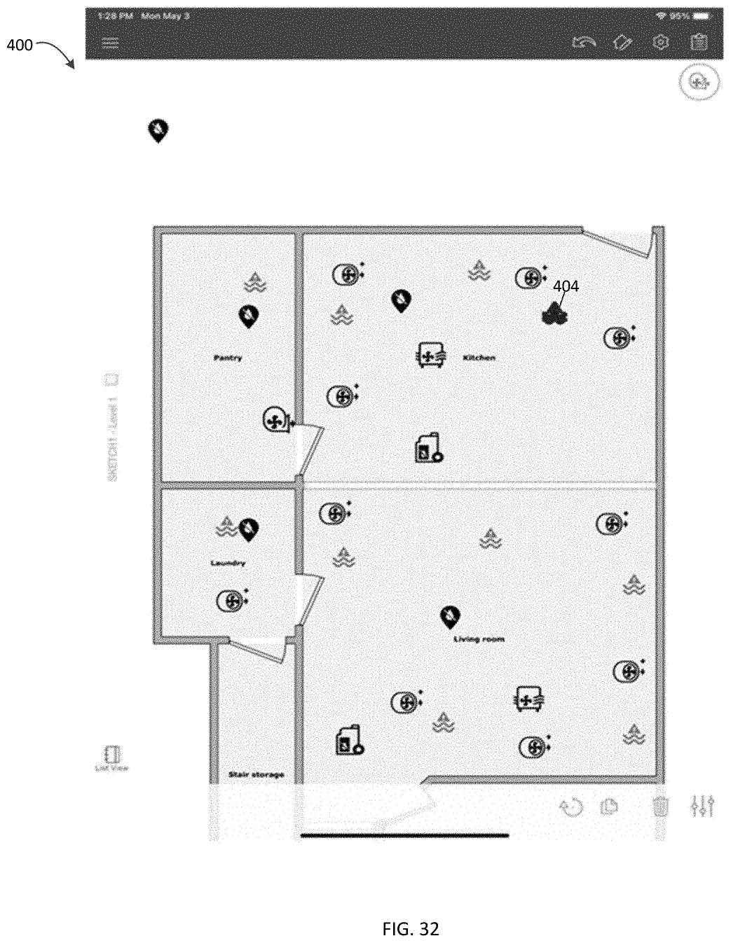

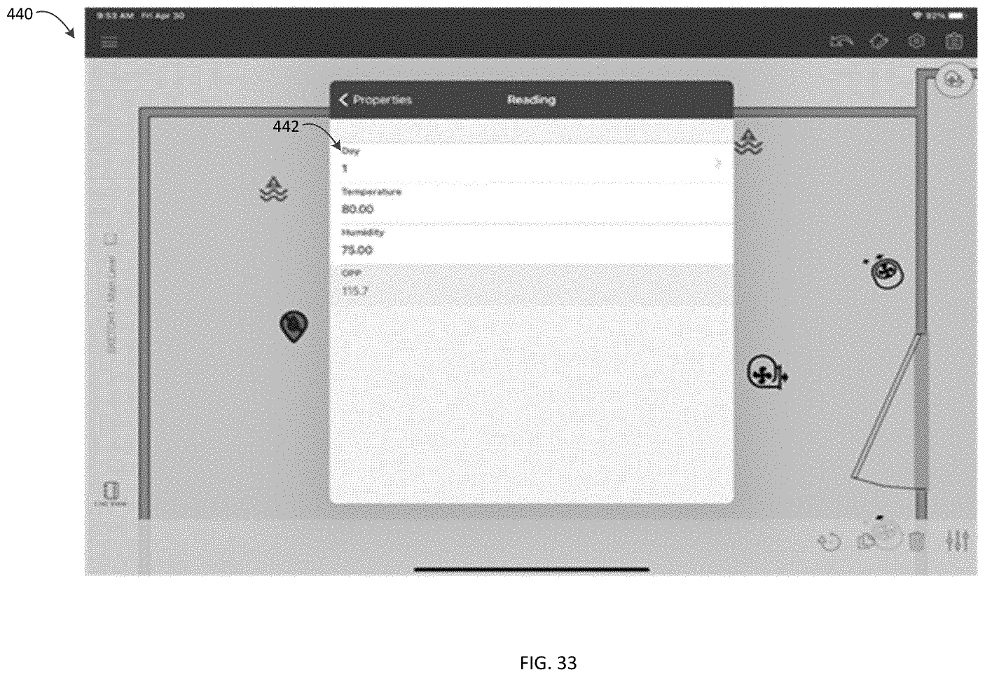

FIGS. 32-34 are diagrams illustrating additional user interface screens generated by the system of the present disclosure, wherein moisture information can be easily logged, accessed, and managed. As shown in FIG. 32, the user can easily access moisture log information by clicking on the moisture log icon 404 displayed in the screen 400. In response, a moisture log fly-out screen can be displayed to the user (discussed in greater detail below), allowing the user to easily and rapidly create and maintain logs related to moisture conditions within a room. As shown in FIG. 33, the user can additionally access information relating to temperature and humidity conditions in the room, using a fly-out screen 442 that can be accessed by tapping on an icon displayed in the screen 440 (e.g., an icon displayed on the floor plan of the structure). The screen 442 includes information relating to the number of days of monitoring, the current temperature, the current humidity, and other information such as grains per pound (GPP) or other information. The information displayed in the screen 442 could be manually entered by the user, and/or automatically provided by humidity and temperature sensing equipment operating in a room of the structure and transmitted to the system (e.g., using a wired or wireless data connection). Moreover, the information provided in the screen 442 could automatically be propagated to other screens of the system, so as to increase the speed with which information related to a water mitigation event occurring in a structure is captured and accessed.

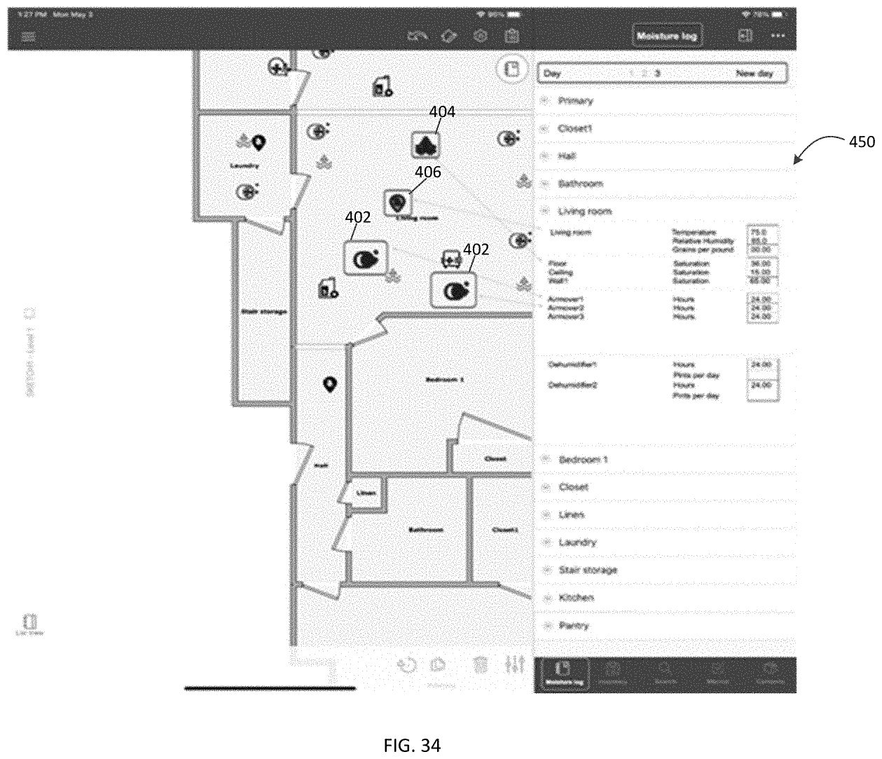

FIG. 34 is a diagram illustrating a moisture log fly-out screen 450 generated by the system (which could be accessed by tapping on one of the moisture log icons discussed above). Advantageously, the information provided by the screen 450 can correspond to numerous types of equipment operating in, and/or water mitigation events occurring within, a structure. For example, the log screen 450 displays information relating to temperature and humidity conditions within the structure (corresponding to the icon 402), information relating to operation of various water mitigation equipment operating in the structure (e.g., various air movers corresponding to the icons 402), and moisture information (e.g., saturation percentages) corresponding to the icon 404. Other information can be readily accessed within the screen 450, such as the number of days in the log, as well as direct access to water mitigation information about other rooms within the structure, such as closets, halls, bathrooms, living rooms, bedrooms, etc. Indeed, as shown in the screen 450, detailed water mitigation information (relating to equipment, environmental conditions, and other information) correspond to a living room is displayed, and the user can access similar information for other rooms in the structure by clicking on one or more of the pull-down icons shown in the screen 450 and corresponding to the other rooms. This causes the screen 450 to expand and to display the water mitigation information for that room(s), thereby greatly increasing the speed with which water mitigation information can be accessed and managed. Once all data has been entered, the data readings, outputs, and affected areas and zones are tabulated by the system into a “drying” report that is meant to show the progress of drying of a particular water mitigation job. Such reports can be provided to insurance carriers and used to determine the performance of equipment and to highlight any irregularities of the drying process. Advantageously, the screen 450 dramatically increases the speed of data entry, access, and management on a jobsite.

It is additionally noted that the system could be utilized to scan one or more QR codes (or, bar codes or other indicia) positioned in a piece of water mitigation equipment, so that information relating to the equipment can automatically be populated into and stored by the system, without requiring manual data entry by the user. Moreover, as noted above, such information could be wirelessly transmitted using a Bluetooth or other wireless (or, wired) data connection between the water mitigation equipment and the system of the present disclosure.

It is noted that the system could be programmed so that the names of each icon 402-414 discussed could be automatically assigned based on the room in which the icon is placed and the type of water mitigation task being undertaken within that room. Also, information relating to hours of operation of a piece of water mitigation equipment could be automatically tabulated so as to calculate the total cost of each piece of equipment. The types of information tracked and/or calculated by the system could include, but is not limited to: hours of equipment operation, days equipment used, temperature, relative humidity, pints of water extracted (which could be automatically calculated by the system), affected/non-affected/outside climate information, grains per pound (which could automatically be calculated), saturation percentage, and other information.

It is additionally noted that the systems and methods discussed herein could automatically obtain operational information from one or more water mitigation devices positioned in a structure, such as air dryers, fans, etc., to ascertain whether such devices are performing adequately to mitigate water damage in a structure. Such information could be automatically telemetered to the system from such devices, e.g., via a wireless data connection (e.g., Bluetooth, WiFi, etc.). By obtaining and monitoring such information, the system can advise property owners, insurers, and other personnel whether the water mitigation devices are appropriately sized for the water mitigation job to be performed, whether such devices are appropriately functioning, and/or whether additional or other devices are required to perform water mitigation devices.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A method for rapidly developing an annotated computer model of water damage relating to a structure, comprising the steps of:
generating a computerized floorplan model of a structure in a user interface of a computer system;
graphically defining at least one area within the floorplan model indicative of water damage;
automatically generating and displaying in the user interface a plurality of questions to be answered by a user of the system based on the at least one area; and
generating, based on respective answers provided by the user to the plurality of questions, a list of actions to mitigate water damage in the at least one area.

2. The method of claim 1, further comprising the steps of:
graphically defining the at least one area by generating a boundary utilizing a user interface tool displayed by the user interface; and
generating, based on the respective answers provided by the user to the plurality of questions, a list of actions to mitigate water damage of the boundary.

3. The method of claim 1, further comprising generating a zone encompassing the at least one area, the zone being indicative of a category and a class of the water damage in the at least one area.

4. The method of claim 1, further comprising the steps of:
positioning at least one piece of equipment within the at least one area that can be utilized to mitigate the water damage in the at least one area by utilizing a user interface tool displayed by the user interface;
automatically generating and displaying in the user interface the plurality of questions to be answered by the user of the system based on the at least one area and the at least one piece of equipment; and
generating, based on respective answers provided by the user to the plurality of questions, a calculation for utilizing the at least one piece of equipment to mitigate the water damage in the at least one area.

5. The method of claim 1, wherein plurality of questions are presented to the user in a guided script.

6. The method of claim 1, wherein the at least one area is indicative of a room or a set of rooms within the floorplan model.

7. A system for rapidly developing an annotated computer model of water damage relating to a structure, comprising:
a computer system having a memory and a display; and
a processor of the computer system, the processor programmed to:
generate a computerized floorplan model of a structure in a user interface of a computer system;
graphically define at least one area within the floorplan model indicative of water damage;
automatically generate and display in the user interface a plurality of questions to be answered by a user of the system based on the at least one area; and
generating, based on respective answers provided by the user to the plurality of questions, a list of actions to mitigate water damage in the at least one area.

8. The system of claim 7, the processor further programmed to:
graphically define the at least one area by generating a boundary based on a user input received from the user of the system utilizing a user interface tool displayed by the user interface; and
generate, based on the respective answers provided by the user to the plurality of questions, a list of actions to mitigate water damage of the boundary.

9. The system of claim 7, the processor further programmed to generate a zone encompassing the at least one area, the zone being indicative of a category and a class of the water damage in the at least one area.

10. The system of claim 7, the processor further programmed to:
position at least one piece of equipment within the at least one area that can be utilized to mitigate the water damage in the at least one area based on a user input received from the user of the system utilizing a user interface tool displayed by the user interface;
automatically generate and display in the user interface the plurality of questions to be answered by the user of the system based on the at least one area and the at least one piece of equipment; and
generate, based on respective answers provided by the user to the plurality of questions, a calculation for utilizing the at least one piece of equipment to mitigate the water damage in the at least one area.

11. The system of claim 7, wherein plurality of questions are presented to the user in a guided script.

12. The system of claim 7, wherein the at least one area is indicative of a room or a set of rooms within the floorplan model.

13. A method for rapidly developing an annotated computer model of a structure, comprising the steps of:
generating a model of the structure;
processing by a computer system the model of the structure, the computer system automatically identifying elements of the model as candidate features for annotation;
displaying the model and the candidate features of the model in a display in communication with the computer system;
selecting and annotating by a user of the computer system the candidate features in the display;
automatically generating and displaying in the display a plurality of questions to be answered by the user of the system based on the annotated candidate features; and
refining the model based on respective answers provided by the user to the plurality of questions.

14. The method of claim 13, wherein the step of processing the model to automatically identify elements of the model as candidate features for annotation comprises identifying exterior surface elements of the model as one of a roof face, a side face, a front face, or a rear face.

15. The method of claim 14, wherein the step of selecting and annotating by the user of the computer system the candidate features in the display comprises grouping the exterior surface elements.

16. The method of claim 13, wherein the model is a two-dimensional or three-dimensional model.

17. The method of claim 13, further comprising the step of generating a list of items requiring repair based on the respective answers provided by the user to the plurality of questions.

18. A system for rapidly developing an annotated computer model of a structure, comprising:
a database; and
a computer system in communication with the database, the computer system:
generating a model of the structure using information from the database;
processing by the computer system the model of the structure, the computer system automatically identifying elements of the model as candidate features for annotation;
displaying the model and the candidate features of the model in a display in communication with the computer system;
selecting and annotating the candidate features in the display based on a user input received from a user of the computer system;
automatically generating and displaying in the display a plurality of questions to be answered by the user of the system based on the annotated candidate features; and
refining the model based on respective answers provided by the user to the plurality of questions.

19. The system of claim 18, wherein the computer system automatically identifies exterior surface elements of the model as one of a roof face, a side face, a front face, or a rear face.

20. The system of claim 19, wherein the computer system annotates the candidate features of the model by grouping the exterior surface elements of the model.

21. The method of claim 1, further comprising obtaining operational information relating to operation of a water mitigation device operating within the at least one area.

22. The system of claim 7, wherein the system obtains operational information relating to operation of a water mitigation device operating within the at least one area.

23. A method for rapidly developing an annotated computer model of water damage relating to a structure, comprising the steps of:
generating a computerized floorplan model of a structure in a user interface of a computer system;
graphically defining at least one area within the floorplan model indicative of water damage;
graphically defining at least one icon corresponding to a water mitigation event or equipment within the at least one area; and
providing access to at least one user interface screen corresponding to the at least one icon, the at least one user interface screen displaying information relating to the water mitigation information event or equipment.

24. The method of claim 23, wherein the water mitigation equipment comprises one or more of an air scrubber, an air mover, or a blower.

25. The method of claim 23, wherein the information relates to one or more operational parameters associated with the water mitigation equipment.

26. The method of claim 25, wherein the information is transmitted from the water mitigation equipment using a wired or wireless connection.

27. The method of claim 23, wherein the information relates to one or more of temperature, humidity, grains per pound, pints of water extracted, or saturation percentage.

28. A system for rapidly developing an annotated computer model of water damage relating to a structure, comprising:
a database; and
a computer system in communication with the database, the computer system:
generating a computerized floorplan model of a structure in a user interface of a computer system;
graphically defining at least one area within the floorplan model indicative of water damage;
graphically defining at least one icon corresponding to a water mitigation event or equipment within the at least one area; and
providing access to at least one user interface screen corresponding to the at least one icon, the at least one user interface screen displaying information relating to the water mitigation information event or equipment.

29. The system of claim 28, wherein the water mitigation equipment comprises one or more of an air scrubber, an air mover, or a blower.

30. The system of claim 28, wherein the information relates to one or more operational parameters associated with the water mitigation equipment.

31. The system of claim 30, wherein the information is transmitted from the water mitigation equipment using a wired or wireless connection.

32. The system of claim 28, wherein the information relates to one or more of temperature, humidity, grains per pound, pints of water extracted, or saturation percentage.
